(19) United States
(12) Patent Application Publication
(10) Pub. No.: US 2025/0086958 A1
(43) Pub. Date: Mar. 13, 2025

(54) VISUAL DESCRIPTION NETWORK

(71) Applicant: SRI International, Menlo Park, CA (US)

(72) Inventors: Richard J. Rohwer, San Diego, CA (US); Andrew C. Silberfarb, Oceanside, CA (US)

(21) Appl. No.: 18/728,049

(22) PCT Filed: Dec. 16, 2022
(86) PCT No.: PCT/US2022/081840

§ 371 Date: Jul. 10, 2024

Related U.S. Application Data
(60) Provisional application No. 63/301,444, filed on Jan. 20, 2022.

(51) Int. Cl. G06V 10/82; G06T 7/246; G06V 10/24; G06V 10/764; G06V 10/776; G06V 20/70

(52) U.S. Cl. CPC G06V 10/82; G06T 7/248; G06V 10/242; G06V 10/245; G06V 10/764; G06V 10/776; G06V 20/70; G06T 2207/20076; G06T 2207/20081; G06T 2207/20084

(57) ABSTRACT

Techniques are disclosed for a soft logic block that can provide visual primitives to soft logic in coordination with a learned attention mechanism. In an example, computing system for object detection, the computing comprising processing circuitry and a storage device, wherein the processing circuitry has access to the storage device and is configured to execute a machine learning system comprising a placement neural network configured to process a patch of image data to generate local placement parameters for aligning a footprint in the patch to a template footprint; and a template comprising a backend network and the template footprint, the template configured to process a transformed footprint comprising the footprint in the patch transformed according to the local placement parameters, to generate a probability value quantifying a likelihood that a particular pattern is present in the footprint.

This application claims the benefit of U.S. Provisional Application No. 63/301,444, filed 20 Jan. 2022, the entire contents of which is incorporated herein by reference.

### TECHNICAL FIELD

This disclosure generally relates to machine learning systems and, more specifically, to machine vision.

### BACKGROUND

Early work on Artificial Intelligence focused on Knowledge Representation and Reasoning (KRR) through the application of techniques from mathematical logic. The compositionality of KRR techniques provides expressive power for capturing expert knowledge in the form of rules or assertions (declarative knowledge), but they are brittle and unable to generalize or scale. Recent work has focused on Deep Learning (DL), in which the parameters of complex functions are estimated from data. Deep learning techniques learn to recognize patterns not easily captured by rules and generalize well from data, but they often require large amounts of data for learning and in most cases do not reason at all.

Deep Adaptive Semantic Logic (DASL) is a framework that applies a form of soft logic to take advantage of the complementary strengths of KRR and DL by fitting a model simultaneously to data and declarative knowledge. DASL enables robust abstract reasoning and application of domain knowledge to reduce data requirements and control model generalization. DASL represents declarative knowledge as assertions in first order logic. The relations and functions that make up the vocabulary of the domain are implemented by neural networks that can have arbitrary structure. The logical connectives in the assertions compose these networks into a single deep network which is trained to maximize their truth.

DASL is described in Sikka et al., “Deep Adaptive Semantic Logic (DASL): Compiling Declarative Knowledge into Deep Neural Networks,” 16 Mar. 2020 (hereinafter, “DASL framework paper”); and is also described in U.S. Publication No. 2020/0193286, titled Deep Adaptive Semantic Logic Network and filed 18 Jun. 2020; each of which is incorporated by reference herein in its entirety.

### SUMMARY

In general, the disclosure describes a soft logic block that can provide visual primitives to soft logic in coordination with a learned attention mechanism. The learned attention mechanism may be similar to the regression head used in some examples of final layers of a deep vision network. The soft logic block “bridges the gap” between the logic of visual descriptions of objects and their spatial relationships (e.g., knowledge about the visual appearances of objects and their spatial relationship) and the visual medium that instantiates their subject matter.

The techniques may provide one or more technical improvements that realize one or more practical applications. For example, by enabling detectors for visual objects and spatial relationships of interest to be created by using knowledge about their visual appearance, the techniques may facilitate the creation of such detectors without the substantial amount of annotated data required for supervised learning, or at least with substantially less annotated data than is typically required for supervised learning. In some examples, the techniques may enable detectors to be created for visual objects and spatial relationships of interest where little to no labeled data exists, e.g., using the logic of visual descriptions of objects and their spatial relationships.

In one example, this disclosure describes a computing system for object detection, the computing system comprising processing circuitry and a storage device, wherein the processing circuitry has access to the storage device and is configured to execute a machine learning system comprising a placement neural network configured to process a patch of image data to generate local placement parameters for aligning a footprint in the patch to a template footprint; and a template comprising a backend network and the template footprint, the template configured to process a transformed footprint comprising the footprint in the patch transformed according to the local placement parameters, to generate a probability value quantifying a likelihood that a particular pattern is present in the footprint.

In another example, this disclosure describes a computing system comprising processing circuitry and a storage device, wherein the processing circuitry has access to the storage device and is configured to receive a specification for a soft logic block, wherein the specification defines: a placement neural network configured to process a patch of image data to generate local placement parameters for aligning a footprint in the patch to a template footprint, and a template comprising a backend network and the template footprint, the template configured to process a transformed footprint comprising the footprint in the patch transformed according to the local placement parameters, to generate a probability value quantifying a likelihood that a particular pattern is present in the footprint; and compile the specification to generate the soft logic block for execution by a machine learning system.

In another example, this disclosure describes a method for detecting an object within image data, the method performed by a computing system executing a machine learning system and comprising: processing, by a placement neural network of the machine learning system, a patch of image data to generate local placement parameters for aligning a footprint in the patch to a template footprint; processing, by a template of the machine learning system, the template comprising a backend network and the template footprint, a transformed footprint comprising the footprint in the patch transformed according to the local placement parameters, to generate a probability value quantifying a likelihood that a particular pattern is present in the footprint; and outputting one or more of an indication of the likelihood that the particular pattern is present in the footprint, a truth value for a presence of the particular pattern in the image data, a location of the footprint in the image data, or an object class represented by the particular pattern.

The details of one or more examples of the techniques of this disclosure are set forth in the accompanying drawings and the description below. Other features, objects, and advantages of the techniques will be apparent from the description and drawings, and from the claims.

### BRIEF DESCRIPTION OF DRAWINGS

FIG. 1A is a block diagram illustrating an example computing system that executes a machine learning system to implement a visual description network, in accordance with the techniques of the disclosure.

FIG. 1B is a block diagram illustrating an example computing system that executes a machine learning system to implement a visual description network, in accordance with the techniques of the disclosure.

FIG. 2 is a block diagram illustrating an example instance of a soft logic block in further detail.

FIG. 3 is a conceptual diagram depicting components and operation of an example soft logic block, according to techniques of this disclosure.

FIG. 4 is a chart using data generated by an example soft logic block.

FIG. 5 is a chart using data generated by an example soft logic block.

FIGS. 6A-6B illustrate sample outputs of a visual description network from images of hail damaged wheat and healthy wheat.

FIG. 7 depicts charts showing example results.

FIGS. 8A-8B depict charts showing example results for an image and the image.

FIG. 9 depicts a representation of a visual description of bridges, in accordance with techniques of this disclosure.

FIG. 10 depict charts showing example results for an image by a pre-processing network and the image, in accordance with techniques of this disclosure.

FIGS. 11A-11B depict charts showing example results for an image by a soft logic block and the image, in accordance with techniques of this disclosure.

FIG. 12 illustrates a learning curve for a soft logic block being trained.

FIG. 13 depicts a legend for tracking output channels of soft logic blocks.

FIG. 14 is a flowchart illustrating an example mode of operation in accordance with the techniques of the disclosure.

FIG. 15 is a flowchart illustrating an example mode of operation in accordance with the techniques of the disclosure.

Like reference characters refer to like elements throughout the figures and description.

### DETAILED DESCRIPTION

To exploit visual descriptions for visual objects of interest to be created by using knowledge about their visual appearance in place of substantial amounts of annotated data, one must build some sort of bridge between the logic of the descriptions and the visual medium that instantiates their subject matter. Described herein is a soft logic block which provides visual primitives to the soft logic in coordination with a learned attention mechanism resembling the regression head sometimes used in the final layers of a deep vision network. The soft logic block may be implemented using any suitable machine learning framework. In some examples, the soft logic block may be implemented using a Python daslLayer class. In such examples, the software logic block may be considered and referred to as a “DASL block”. The terms “DASL block” and “daslLayer” may be used interchangeably throughout this disclosure, though daslLayer will tend to denote a software class for defining and implementing a DASL block that is an example implementation of a soft logic block. Several soft logic blocks can be stacked to form a deep vision architecture referred to herein as a “visual description network.” Alternatively, one or more soft logic blocks can be inserted into existing vision architectures at any level where one has relevant knowledge.

This disclosure describes the soft logic block and its supporting software, as well as the information-theoretic loss function that drives both feature learning and attention. The disclosure also describes issues that arise from using logic and information together. The techniques of this disclosure are illustrated and described with respect to example results.

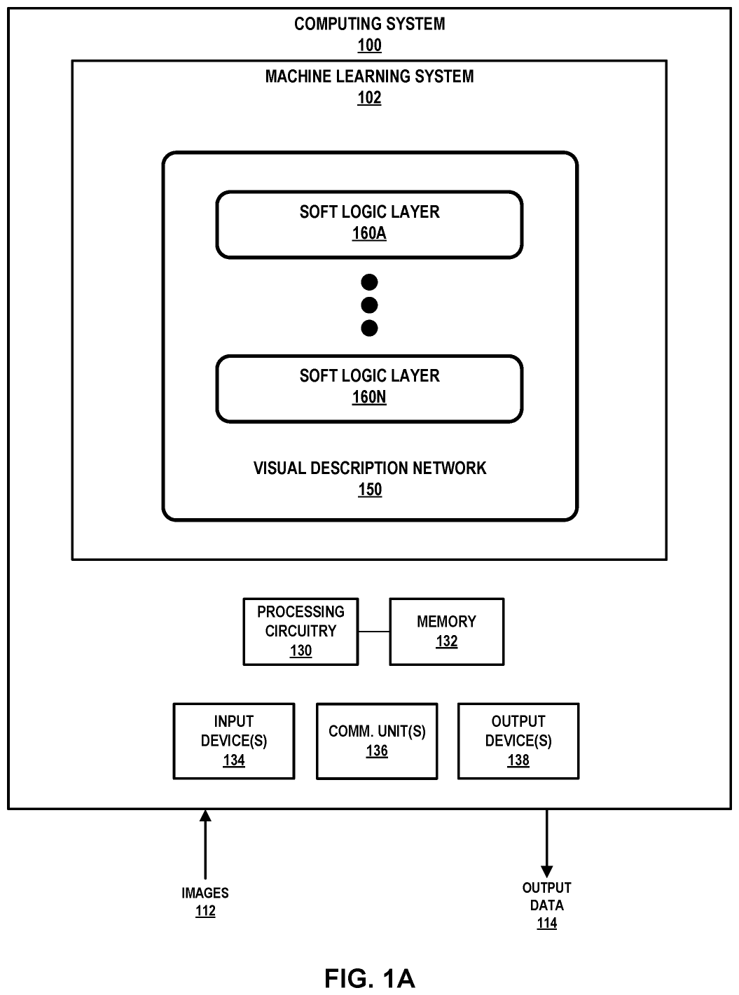

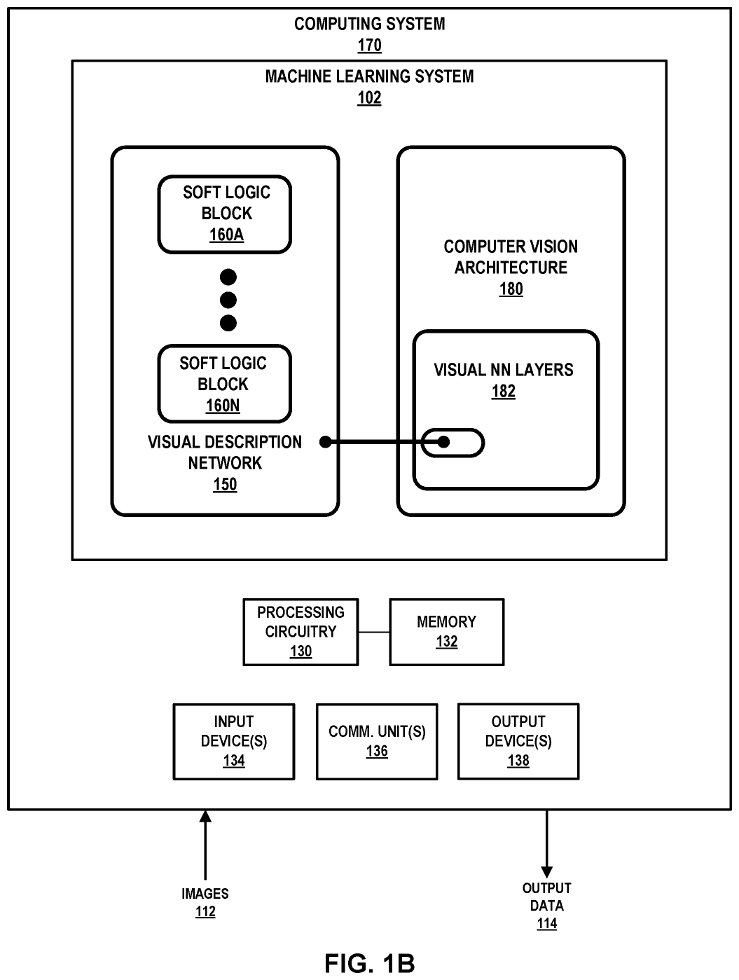

FIG. 1A is a block diagram illustrating an example computing system that executes a machine learning system to implement a visual description network, in accordance with the techniques of the disclosure. Computing system 100 represents one or more computing devices configured for executing a machine learning system 102. In some aspects, computing system 100 includes processing circuitry 130 and memory 132 that can execute components of machine learning system 102. Such components may include, as shown, a plurality of stacked soft logic blocks 160A-160N (hereinafter, “soft logic blocks 160”) that may form an overall visual description network 150 for performing one or more techniques described herein. Some examples of visual description network 150 may have a single soft logic block.

Computing system 200 includes processing circuitry 130, memory 132, one or more input devices 134, one or more communication units 136, and one or more output devices 138 to execute machine learning system 102.

In some examples, processing circuitry 130 of computing system 100 includes one or more of a microprocessor, a controller, a digital signal processor (DSP), an application specific integrated circuit (ASIC), a field-programmable gate array (FPGA), or equivalent discrete or integrated logic circuitry, or other types of processing circuitry. In another example, computing system 100 comprises any suitable computing system having one or more computing devices, such as desktop computers, laptop computers, gaming consoles, smart televisions, handheld devices, tablets, mobile telephones, smartphones, etc. In some examples, at least a portion of system 100 is distributed across a cloud computing system, a data center, or across a network, such as the Internet, another public or private communications network, for instance, broadband, cellular, Wi-Fi, and/or other types of communication networks, for transmitting data between computing systems, servers, and computing devices.

Memory 132 may comprise one or more storage devices. One or more components of computing system 100 (e.g., processing circuitry 130, memory 132, etc.) may be interconnected to enable inter-component communications (physically, communicatively, and/or operatively). In some examples, such connectivity may be provided by a system bus, a network connection, an inter-process communication data structure, local area network, wide area network, or any other method for communicating data. Processing circuitry 130 of computing system 100 may implement functionality and/or execute instructions associated with computing system 100. Examples of processing circuitry 130 include microprocessors, application processors, display controllers, auxiliary processors, one or more sensor hubs, and any other hardware configured to function as a processor, a processing unit, or a processing device. Computing system 100 may use processing circuitry 130 to perform operations in accordance with one or more aspects of the present disclosure using software, hardware, firmware, or a mixture of hardware, software, and firmware residing in and/or executing at computing system 100, and may be distributed among one or more devices. The one or more storage devices of memory 132 may be distributed among one or more devices.

Memory 132 may store information for processing during operation of computing system 100. In some examples, memory 132 comprises temporary memories, meaning that a primary purpose of the one or more storage devices of memory 132 is not long-term storage. Memory 132 may be configured for short-term storage of information as volatile memory and therefore not retain stored contents if deactivated. Examples of volatile memories include random access memories (RAM), dynamic random access memories (DRAM), static random access memories (SRAM), and other forms of volatile memories known in the art. Memory 132, in some examples, also include one or more computer-readable storage media. Memory 132 may be configured to store larger amounts of information than volatile memory. Memory 132 may further be configured for long-term storage of information as non-volatile memory space and retain information after activate/off cycles. Examples of non-volatile memories include magnetic hard disks, optical discs, Flash memories, or forms of electrically programmable memories (EPROM) or electrically erasable and programmable (EEPROM) memories. Memory 132 may store program instructions and/or data associated with one or more of the modules described in accordance with one or more aspects of this disclosure.

Processing circuitry 130 and memory 132 may provide an operating environment or platform for one or more modules or units including those of machine learning system 102, e.g., soft logic blocks 160 of visual description network 150, which may be implemented as software, but may in some examples include any combination of hardware, firmware, and software. Processing circuitry 130 may execute instructions and the one or more storage devices, e.g., memory 132, may store instructions and/or data of one or more modules or units, e.g., those of machine learning system 102. The combination of processing circuitry 130 and memory 132 may retrieve, store, and/or execute the instructions and/or data of one or more applications, modules, units, or software. The processing circuitry 130 and/or memory 132 may also be operably coupled to one or more other software and/or hardware components, including, but not limited to, one or more of the components illustrated in FIG. 1A.

Processing circuitry 130 may execute machine learning system 102 using virtualization modules, such as a virtual machine or container executing on underlying hardware. Modules or units of machine learning system 102 may execute as one or more services of an operating system, computing platform, and/or cloud computing platform. Aspects of machine learning system 102 may execute as one or more executable programs at an application layer of a computing platform.

One or more input devices 134 of computing system 100 may generate, receive, or process input. Such input may include input from a keyboard, pointing device, voice responsive system, video camera, biometric detection/response system, button, sensor, mobile device, control pad, microphone, presence-sensitive screen, network, or any other type of device for detecting input from a human or machine. The above example devices may represent one or more of input devices 134.

One or more output devices 138 of computing system 100 may generate, transmit, or process output. Examples of output, tactile, audio, visual, and/or video output. Output devices 138 may include a display, sound card, video graphics adapter card, speaker, presence-sensitive screen, one or more USB interfaces, video and/or audio output interfaces, or any other type of device capable of generating tactile, audio, video, or other output. Output devices 138 may include a display device, which may function as an output device using technologies including liquid crystal displays (LCD), quantum dot display, dot matrix displays, light emitting diode (LED) displays, organic light-emitting diode (OLED) displays, cathode ray tube (CRT) displays, e-ink, or monochrome, color, or any other type of display capable of generating tactile, audio, and/or visual output. In some examples, computing system 100 may include a presence-sensitive display that may serve as a user interface device that operates both as one or more input devices 134 and one or more output devices 138. The above example devices may represent one or more of output devices 134.

One or more communication units 136 of computing system 100 may communicate with devices external to computing system 100 (or among separate computing devices of computing system 100) by transmitting and/or receiving data and may operate, in some respects, as both an input device and an output device. In some examples, communication units 136 may communicate with other devices over a network. In other examples, communication units 136 may send and/or receive radio signals on a radio network such as a cellular radio network. Examples of communication units 136 include a storage device interface, network interface card (e.g. such as an Ethernet card), an optical transceiver, a radio frequency transceiver, a GPS receiver, or any other type of device that can send and/or receive information. Other examples of communication units 136 may include Bluetooth®, GPS, 3G, 4G, and Wi-Fi® radios found in mobile devices as well as Universal Serial Bus (USB) controllers and the like.

The image classification problem is to assign an entire image to one of some given set of categories. In accordance with the techniques of the disclosure, machine learning system 102 implements soft logic blocks 160 to address the object detection problem, which adds the complication of detecting whether and where an object occurs within an image to the problem of assigning it to a category. To perform object detection, attention must be directed to the region within the image in which the object is manifest. Reference herein to “an object” or “an object of interest” may refer to an individual object, as well as to multiple objects and the spatial relationships among the multiple objects, recognizing that objects are the collection and arrangement of yet more primitive objects.

A set of like-sized images is commonly represented by a 4-dimensional array. The first dimension indexes the image, the second dimension a vertical pixel coordinate (from the top), the third dimension a horizontal pixel coordinate (from the left), and the fourth/final dimension some number of channels—typically 3 channels for red, green and blue (RGB) intensities. This is the dimension order typically used by image display software. Convolutional network software typically puts the channel dimension immediately after the first—the so-called “batch dimension.”

Computer vision neural network models commonly involve feed-forward stacks of layers that retain this basic structure, except that the number of channels varies, and the horizontal and vertical coordinates refer to an evenly spaced grid of (usually overlapping) rectangular patches instead of single pixels. Output channel values may be computed as learned functions of the channels within each patch. In some cases, the grid is foregone in favor of a collection of interest points that can be placed anywhere. Output channel values may be computed at each interest point based on inputs in its vicinity, the shape and size of which can be defined by the operator.

Each of soft logic blocks 160 uses a grid system to support its attention mechanism and an interest point system for computing channel content. At present, however, the interest points are restricted to a grid. This provides a technical advantage, for whereas the grid implementation involves copying the content of all the patches into an array, the point implementation does not, and thereby saves potentially significant amounts of memory. In some examples, the attention mechanism is ported to a point system to enable the attention mechanism to vary the interest point locations. The grid implementation provides this feature is a limited way. At the lowest layer where no attention mechanism has had an opportunity to operate, the points would still be set out on a grid.

Each of soft logic blocks 160 receives as input a 4-dimensional array (e.g., a PyTorch tensor) and produces another (with generally different dimension sizes, except for the batch dimension) as output, which makes soft logic blocks 160 stackable (as shown in FIG. 1A). In some examples, an internal data structure of one or more of soft logic blocks 160 is exposed for use directly as output to other components of visual description network or other network architecture components.

### The DASL Model

In examples that use an implementation of the DASL framework described in the DASL framework paper, much of the functionality of each of soft logic blocks 160 may be implemented as a logical theory expressed in terms of a DASL Model compiled into a DaslNet. A DaslNet may be a deep neural network (DNN) compiled from knowledge, expressed in first order logic, and domain-specific neural components. The DNN may be trained using backpropagation, fitting both the data and the knowledge. A DaslNet may be a PyTorch nn.Module (neural network module). At a top level, the DASL framework is a tool that compiles logical statements into a PyTorch Module (torch.nn.Module) called a DaslNet (dasl.DaslNet). A DaslNet can be used just like any other PyTorch module. It can be executed, trained, used as a component of another module, persisted, etc. To build a DaslNet, a user may provide two key inputs: a language model and a theory.

A language model may be implemented as a DASL model (dasl.Model), and consists of a mapping from names to implementations. The DASL framework provides the user the ability to invent an arbitrary first-order language containing entities, predicates and functions, collectively referred to as components.

This language is constructed when the user adds implementations of each component to the model. Each component may be implemented by any callable object (e.g. callable (comp)==True), such as a python function, a python class with a_call_method, or a torch.nn.Module with trainable parameters. Components are added to a model using standard python dictional semantics mdl[“CompName”]=CompImplementation. When initialized (mdl=dasl.Model( )) a model already contains a number of components corresponding to logical connectives, quantifiers, and utility functions. All model components can be seen by printing the model (print (mdl)).

A theory is a text string written using the language defined in the model, including the standard pre-defined connectives (&, |, ->). Generally, a user will write multiple theories corresponding to a single model. For example, a user may create a theory from a set of assertions which she will use to train the model, a set of theories corresponding to interesting queries, and yet another complex theory that she believes should be entailed by the first set of assertions. The DASL framework provides a powerful macro mechanism to support more effective theory construction, whereby sub-theories may be constructed, named and reused in more complex theories. Macros can be added to the model (mdl.define(“thy Name=a & (b|c)”)), and the named macros may then be used just like any other model component. Macros also support arguments (mdl.define (“thyFun(a,b)=a & ˜b”)). In practice a user will usually write a theory as a set of single line macros that are added to the model, and the actual theory text will be a single macro name.

Once a user has written a theory and built a model that implements all of the components referenced in the theory, they may then compile the theory into a DaslNet (dnet=dasl.compile (theory, mdl)). The DaslNet may be executed as (result=dnet( )). Assuming all user provided functions are differentiable (by torch.autograd( )) then the full DaslNet will be differentiable and can be trained. DASL operates on tensors, and the result may be an arbitrary tensor based on how the theory and the model interact. DaslNets can also support input arguments, multiple output arguments, and parallel execution over a mini-batch. At this point the DaslNet may be used just like and other PyTorch Module.

The DASL framework implements all standard logical operations using a numerically stable and accurate log it representation, which preserves gradients through arbitrarily complex, nested logic. All logical inputs and outputs to DASL (as well as intermediate representations) are represented as log its. For training of logical theories DASL provides a loss function (dasl.logic_loss( )) which is a specialized implementation of binary cross entropy that assumes the target is 1.0 (True). Additional details of the DASL framework and the use of a DASL model compiled into a DaslNet may be found in Richard Rohwer, “DASL3”, 26 Jan. 2021, available at https://dasl.gitlabpages.sri.com/dasl/tex/das13doc.pdf, which is incorporated by reference herein in its entirety.

A soft logic model for any of soft logic blocks 160 includes logic describing objects of interest, as well as low-level vision operations needed to express the logic, or other information. This is made possible by the ability to associate arbitrary functions with names in a soft logic model. In examples that rely on the DASL framework, the daslLayer constructor for any of soft logic blocks 160 builds the theory and populates a DASL Model implementation of the soft logic model automatically from specifications supplied via its arguments.

A sequence of soft logic blocks 160 can be stacked in two mathematically equivalent ways. Soft logic blocks 160 can share a soft logic model so that the theory can use the name of the output of one layer as the name of the input to the next. (These names may be supplied by daslLayer constructor arguments.) Alternatively, the output returned by one of soft logic blocks 160 can be supplied as an input argument to the next one of soft logic blocks 160 in the sequence. The former arrangement produces a single theory and corresponding DASLnet for the entire network when using the DASL framework. This arrangement may be supported by the DaslStack class when using the DASL framework. Oftentimes this approach proves to be too computationally intensive for the Lark parser used by DASL. The latter arrangement circumvents this problem and offers the potential advantages of enabling separate namespaces for the soft logic blocks 160 and support for completing training of one layer before starting on the next, when a suitable loss function is available for each layer. This arrangement may be supported by the BrokenDaslStack class when using the DASL framework.

### The Soft Logic Block Overall Organization and Rationale

Visual descriptions are framed in terms of objects that exhibit spatial relationships. Spatial relationships are grounded in the geometry of the image plane, which makes them relatively easy to map into a logical vocabulary. The vocabulary of ‘fiducial placements’ enables the operator to define complex patterns in terms of relative placements of footprints within a frame of reference anchored to the footprints, not the image.

Objects themselves are more difficult to frame as a visual descriptions. In principle, one could take the view that each pixel constitutes a primitive type of object from which all more complex objects are defined in terms of their color vectors and spatial inter-relationships, but such a low-level description would hardly ever be amenable to expressing prior knowledge. Each of soft logic blocks 160 defines the lowest-level objects as learned features of the pixels within a region around an interest point called a footprint. These features, or rather their occurrence probabilities, are given by a backend neural network also referred to as the “backendNet,” the inputs to which are all the channels of all the pixels within a footprint (or some other vector of channels passed in from a prior soft logic block). The backendNet output channels can then be used as inputs to the logic. To do so, one arbitrarily selects the backendNet output channel to associate with any particular object class. It is expected that, in learning to make its output channels respect the logic under this imposed interpretation, the backendNet will have to learn, in effect, to label the object instances accurately. In this sense, learning is indirectly supervised by the prior knowledge.

It is not a requirement that the backendNet outputs be interpreted logically. An alternative is to present them directly to a loss function that treats them as unsupervised features. These can be treated as primitive objects that ground the logic of a subsequent layer, or merely passed to a conventional supervised learning network.

In order for a backendNet to learn to recognize objects of a particular class, the backendNet must receive similar input from its footprint content at each instance of the class. But those representative input patterns cannot be expected to occur neatly centered at interest points of some arbitrarily defined grid; in general, they will occur at some offset from the nearest grid point, with different offsets from different grid points. Furthermore, some instances may appear rotated relative to others, or be somewhat larger or smaller than average. To compensate for these variations, each of soft logic blocks 160 has a learned placement attention mechanism that maps the variants onto the footprint.

A placement is defined in some examples as a triple: (shift, scale, angle). The shift is a pair (dy, dx) containing a vertical (downward) coordinate difference dy and a horizontal coordinate difference dx. The coordinates are in units of pixels, where the term is used with reference to the grid of the layer below, even if the grid points are spaced across several pixels of the input image. A scale is a pair (sh, sw) of vertical and horizontal multiplicative factors (usually chosen equal). An angle θ specifies a counterclockwise rotation of the footprint (not the image) and is represented by the pair (sin θ, cos θ) to avoid the modulo 2π discontinuity. The rotation may be applied first so the shift is not rotated. The scaling may be applied last so the shift is scaled.

A footprint can have any shape. A footprint is defined by a list of coordinates relative to the interest point. When a footprint is “placed”, i.e., that a placement has been applied to the footprint, the resulting coordinates will usually not be integer valued. Channel values at these non-integral locations may be computed from a bilinear interpolation or other interpolation of nearby pixels., e.g., the four nearest pixels.

The placement parameter values are supplied by the output of a placement neural network, also referred to as the “placementNet,” that takes a rectangular patch of pixels around the interest point as inputs. At the input layer, placement information remains to be determined, leading to the inputs being a grid of patches. But at higher layers, placement and other information is available from the layers below, so more sophisticated approaches become possible. In some examples, a soft logic block 160 is defined to compute an average placement from the placements of the various inputs. In some examples, a soft logic block 160 is defined to use a placementNet to compute a differential from such an average. From its off-center, off-angle, off-scale view, the placementNet is tasked with determining how to “place” footprints in its vicinity. A placementNet is not required to supply all three placement parameters; they can be defaulted to zero shift, unit scale, and zero angle. For example, in terrestrial imagery where ‘up’ is a special direction that is always vertical in the images, it is appropriate not to do rotations.

The placementNet is not tasked with determining the object class involved; that task may be performed by the backendNet. However, that intention may be expressed in order to prevent the backendNet from choosing to regard the ‘same’ object in different placements as different classes of object. This topic is described in the discussion of loss functions elsewhere in this disclosure.

A situation may arise in which different classes of objects should be placed differently. In that case, multiple placementNets and multiple backendNets may be defined, and it may be required that particular placementNets are to be used together with particular backendNets, or particular channels of a backendNet. Much of the daslLayer class for defining soft logic blocks 160 is devoted to providing manageable ways of specifying these and still more complicated combinations of options.

With respect to spatial relations among objects, soft logic blocks 160 express explicit spatial relations (as opposed to those implicit in footprints with their backendNets) using much of the same machinery as is used to express placements.

Complex object descriptions can be built from assertions that particular component objects are situated at particular distances and angles from each other, provided there is clarity about the frame of reference to use. This frame should be defined relative to the component objects involved. The usual procedure starts with using a single placementNet to define a coordinate system shared by all the component objects. The origin is defined by the shift (from the interest point) and the axes by rotating the image axes through the given angle. This is referred to as the fiducial coordinate system. Rather than directly specify how the component objects of every pair are situated relative to each other, objects are specified by location within the fiducial coordinate system. This can be specified by supplying a fiducial shift for each component object, meaning a shift defined relative to the fiducial coordinate system instead of the image coordinate system. Fiducial angles for components may be specified to define orientations for their respective footprints. Finally, fiducial scales may be specified to make some components bigger or smaller than others. Taken together, this triple forms a fiducial placement with the same structure, relative to the fiducial frame, as an ordinary placement has with respect to the image frame. However, an ordinary placement is local in the sense that it varies with interest point, whereas a fiducial placement is a global property of all instances of the complex object described. The adjective ‘local’ is used herein to emphasize the distinction.

An object's overall placement (local followed by fiducial) determines the content of its footprint, from which (an output channel of) its backendNet determines its class. This output may be interpreted as the probability that the object is present, and this output is referred to as an unstructured predicate—‘unstructured’ in that it is not the output of a logic formula. However, unstructured predicates can serve as inputs to logic formulas, expressed for instance in DASL, and in this role they form the bridge between visual primitives and descriptive logic. The output of a logic formula is referred to as a structured predicate (though in general it might be a function). A structured predicate can take structured and/or unstructured predicates as input. Typically, a complex object is described as a simple conjunction of component objects: “This component placed here and that one there, etc.” But disjunctions, negations and implications can also be employed for greater expressive power. In general, a predicate is a mapping from a tuple of zero or more entities to a truth value, also called a Log it. If the predicate has no arguments, then it is in effect a name for a Boolean value. If a predicate has one argument, it asserts a property. If a predicate has two or more arguments, it asserts a relation between entities.

Using the logic of visual descriptions of objects and, in some cases, their spatial relationships, which have been provided by an operator, soft logic blocks 160 can be trained by feeding the predicates into an objective loss function. That is, machine learning system 102 trains neural network components of the one or more soft logic blocks 160 to map image regions into footprint ‘local placements’ at learned shifts, rotations, and scales relative to given interest points so as to apply a learned attention mechanism when operating in inference mode. The one or more soft logic blocks 160 apply the transformations suggested by the learned attention mechanism (placementNet) to at least the relevant portions the input image to produce a fiducial frame. The one or more soft logic blocks 160 apply the trained logic network (backendNet) to generate output values from the content of locally and fiducially placed footprints, and logic may be applied to output values, considered as unstructured predicates, to generate one or more probability values that quantify a likelihood that a particular pattern (defined at least in part by the so-called “template footprint”) is present in the footprint that has been locally placed. In this way, the one or more soft logic blocks 160 can determine and output a likelihood that the particular pattern defined for a backend network is present in an input image. With knowledge of the transformations and the local and fiducial frames, the one or more soft logic blocks 160 may further determine and output a location of the particular pattern within the input image. The soft logic blocks 160 may be trained layer by layer to train a deep network without deep learning.

By enabling configuration of computing system 200 to detect visual objects and spatial relationships of interest by using knowledge about their visual appearance, the techniques may facilitate such configuration without the substantial amount of annotated data required for supervised learning, or at least with substantially less annotated data than is typically required for supervised learning. In some examples, the techniques may enable configuration of computing system 200 detecting for visual objects and spatial relationships of interest where little to no labeled data exists, e.g., using the logic of visual descriptions of objects and their spatial relationships.

Network models for the networks described in this disclosure, trained by machine learning system 102 and used for inference/prediction, may be machine learning (ML) models. The training and use of ML models may be separated. For example, a machine learning system 102 may train the one or more soft logic blocks 160 to produce trained ML models for soft logic blocks 160. These trained ML models may be output for use in prediction systems, or “detectors”, that make use of the trained ML models for object detection in the field, for instance.

In some examples, machine learning system 102 may independently train the one or more soft logic blocks 160 to produce trained ML models for soft logic blocks 160 for different objects or spatial relationships of interest. For example, soft logic blocks 160 may be fully trained to detect object A, and these trained object A-detecting soft logic blocks 160 may be output for use by a first detector. Soft logic blocks 160 may be separately fully trained to detect spatial relationship B among multiple objects, and these trained spatial relationship-detecting soft logic blocks 160 may be output for use by a second, different detector.

In some examples, machine learning system 102 is configured to train deep learning ML models. Deep learning ML models may require more data than basic ML models or statistical ML models but may be able to provide more sophisticated types of predictions. Example types of deep learning ML models may include Long Short-Term Memory (LSTM) models, bi-directional LSTM models, recurrent neural networks, or other types of neural networks that include multiple layers. In other examples, soft logic blocks 160 may use neural network models other than deep learning ML models.

The ML models may be grouped as regression-based ML models, classification-based ML models, and unsupervised learning models. There may be baseline, statistical, and deep learning MLs for each of these groups. Example types of regression-based baseline ML models may include a hidden Markov model and season trend decomposition approaches. Example types of regression-based statistical ML models may include Error-Trend-Seasonality (ETS) models (including exponential smoothing models, trend method models, and ETS decomposition), EWMA models (including simple moving averages and EWMA), Holt Winters models, ARIMA models, SARIMA models, vector autoregression models, seasonal trend autoregression (STAR) models, and Facebook PROPHET models. Example types of regression-based deep learning ML models may include LSTM architectures (including single-layer LSTMs, depth LSTMs, bi-directional LSTMs), RNNs, and gated recurrent units (GRUs). Example types of classification-based baseline ML models may include logistic regression models and K-nearest neighbor models. Example types of classification-based statistical ML models may include support vector machines and boosting ensemble algorithms (e.g. XGBoost). Example types of classification-based deep learning ML models may include LSTM architectures, RNN architectures, GRU architectures, and artificial neural network architectures. Example types of unsupervised ML models may include K-means clustering models, Gaussian clustering models, and density-based spatial clustering. These ML models may be combined, in some examples with one or more DNNs, to produce an overall neural network architecture for any of soft logic block 160.

FIG. 1B is a block diagram illustrating an example computing system that executes a machine learning system to implement a visual description network, in accordance with the techniques of the disclosure. Computing system 170 of FIG. 1B is similar to computing system 100 of FIG. 1A but includes a computer vision architecture 180.

Computer vision architecture 180 represents a neural network (NN) architecture for computer vision and includes multiple visual NN layers 182. Visual description network 150 having one or more soft logic blocks 160 is included in computer vision architecture 180, for example as one of visual NN layers 182. Outputs of any of soft logic blocks 160 may be inputs to other components of computer vision architecture 180, and soft logic blocks 160 may have inputs that are outputs of other components of computer vision architecture 180. As such, soft logic blocks 160 may be inserted into other computer vision architectures at a level in which there is relevant knowledge.

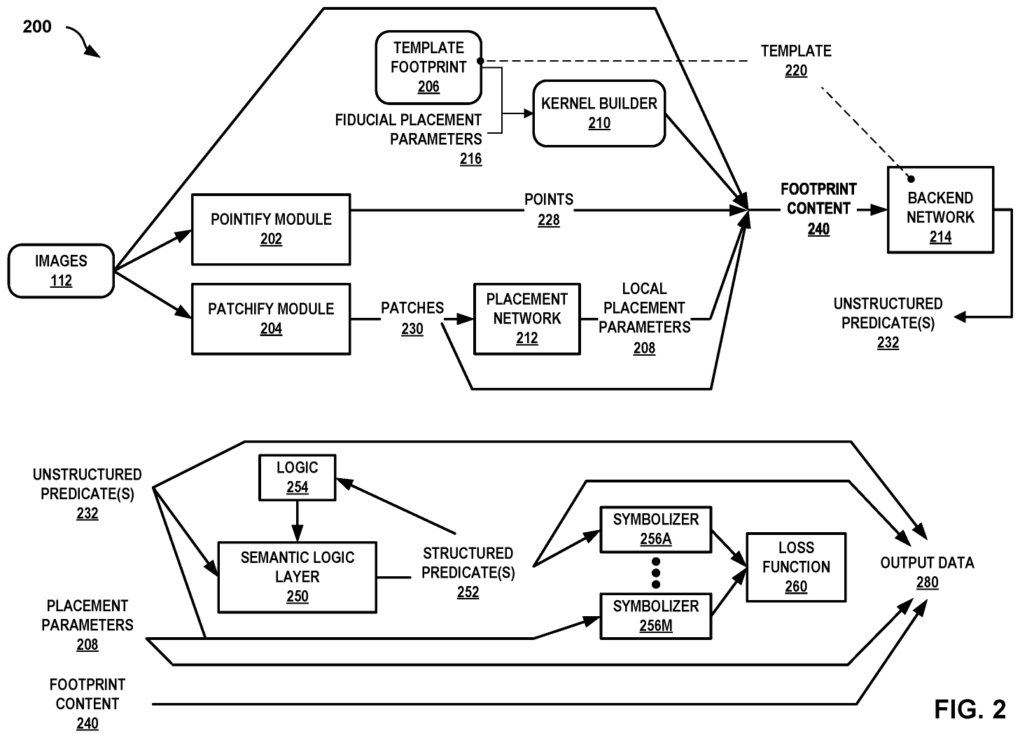

FIG. 2 is a block diagram illustrating an example instance of a soft logic block in further detail. Soft logic block 200 may represent any of soft logic blocks 160. Soft logic block 200 processes images 112 to produce output data 280, which may include an indication of a likelihood that a particular pattern represented by logic of template footprint 206 is present in one of images 112.

Soft logic block 200 includes pointify module 202 (“pointifier” elsewhere herein) and patchify module 204 (“patchifier” elsewhere herein) to pre-process input images 112. Input images 112 may be represented as a multi-dimensional array, as described above. Like a normal visual NN layer, soft logic block 200 may transform 4D “input” data on one evenly-spaced rectangular grid into 4D “output” data on another, according to one of the following conventions:
(D) Dasl/Display convention: −1 (i.e., 3) [B,H,W,C]
(C) Convolution convention: 1 [B,C,H,W]

Constructor args iCin and iCout, which can take the values 1 or 3, indicate which convention the input follows and the desired convention for the output. Input images 112 may include images for object detection or other prediction/inference, images for use as training data for soft logic block 200, or both.

To support the grid-based approach, pointify module 202 transforms an input image into patches 230 of a given edge dimensions (“stride”). Patches 230 are rectangular, typically square. As explained above, horizontal and vertical coordinates refer to an evenly spaced grid of (usually overlapping) rectangular patches 230 instead of single pixels. Pointify module 204 generates points 228 that includes the patch center points for patches 230. Patches 230 are input to placement network (a placementNet) that outputs local placement parameters 208. Placement network 212 is a neural network trained to process image data, e.g. patches 230, to generate local placement parameters 208 for aligning a footprint in the patches to template footprint 206. Local placement parameters 208 may include one or more of a 2-dimensional (2D) shift vector (Sh: dy, dx), a 2D vector of local scaling parameters (Sc: sh, sw), or a 2D unit vector representation of an angle of rotation (A: sin θ, cos θ). Local placement parameters 208 in this way specify a suggested transformation for a portion of the image data for an input image, which may be represented by at least some of patches 230 and points 228.

Template 220 includes two components: template footprint 206 and corresponding backend network 214. Template footprint 206 can have any shape and is useful for identifying patterns in image data. Template footprint 206 is defined by a list of coordinates relative to an interest point. Soft logic block 200 defines the lowest-level objects as learned features of the pixels within a region around an interest point, which corresponds to template footprint 206 that has been “placed” according to the transformation defined by local placement parameters 208 suggested by placement network 212. These features, or rather their occurrence probabilities, are then computed by backend network 214, the inputs to which are all the channels of all the pixels within a placed footprint on the portion of the image data of the input image being processed.

Template footprint 206 may be a [n, 2] tensor of input grid coordinates relative to an origin that is usually chosen to be near their centroid. The coordinates are typically integers but can be real. Fiducial placement parameters 216 (“fidPlacement” elsewhere herein) is a set of placement parameters similar to local placement parameters 208, but fiducial placement parameters 216 do not vary with the patches. Fiducial placement parameters 216 may be used to define new footprints in terms of existing footprints by applying the placement transformation. Fiducial placement parameters 216 include one or more of fiducial shift, fiducial scale, or fiducial angle, and may be used to define a fiducial coordinate system.

From template footprint 206 and placement parameters, kernel builder 210 interpolates image data, e.g., included in patches 230, onto template footprint 206, after transformation using learned local placement parameters 208 suggested by placement network 212. Kernel builder 210 may include an interpolation kernel to perform the interpolation. The interpolated image data is included in footprint content 240, which serves as input to backend network 214. As shown, footprint content 240 may also include one or more of local placement parameters 208, patches 230, and input images 112. In this way, kernel builder 210 applies the placement parameters to perform one or more of shifting, scaling, or rotating the footprint template to identify image data comprising pixels included in the footprint template, and interpolates channel data of the image data to generate the transformed footprint in the image data or, more specifically, the patch.

Soft logic block 200 may include multiple instances of template footprint 206, sets of fiducial placement parameters 206, instances of placement network 212, instances of backend network 214, and/or sets of logical axioms that can be employed in a variety of combinations.

Soft logic block 200 may include multiple templates 220, each template including a template footprint 206 and a corresponding backend network 214. Only one template 220 is shown for ease of illustration and understanding. Backend network 214 processes footprint content 240 including interpolated image data to generate unstructured predicates 232. However, in some examples, backend network 214 may process patches 230 directly to generate unstructured predicates 232. The number of inputs to backend network 214 may match the number of locations in the footprint content 240 to which it is applied, multiplied by the number of input channels. In principle, two footprints with different shapes but the same number of locations could supply input to the same backend network 214. However, as described herein, every instance of a backend network 214 has a unique, corresponding template footprint 206. The converse need not hold; multiple different instances of backend network 214 can be applied to a single template footprint 206, or with similar effect, a single instance of backend network 214 with multiple output channels can be applied.

Fiducial placement parameters 206 are typically used to express symmetries using tied backend network 214 parameters. Consider, for example, a thin horizontal rectangular footprint. Fiducial placement parameters 206 can be used to define a vertical stack of copies of this footprint. By applying the same backend network 214 to all of them, it becomes possible to detect the degree of presence or absence of the same features (one per channel) for each. Logic may then be applied to detect whether any particular feature is the same or different in each placement, or the same for some while different for others, depending what type of symmetry the operator seeks to detect. Similar remarks can be made for rotations and scalings as for the vertical translations of this example. From a programming standpoint, it is important to:
Have a way to define the ensemble of fiducial placement parameters 206,
To express that a single backendNet is applied to each member of that ensemble, and
To keep track of the resulting predicates from the various channels and applications of fiducial placement parameters 206 so that subsequent logic can be applied to them without confusion.

An operator defining soft logic block 200 can choose between a multiplicity of instances of backend network 214, a multiplicity of channels in a single backend network 214, or a combination of the two. For example, to create tied detectors for each of two ensembles of fiducial placement parameters 206, soft logic block 200 may be defined to have a single-channel backend network 214 for each, or a single 2-channel backend network 214, and connect one channel to the logic about one ensemble and connect the other channel to the logic about the other. The latter strategy may be preferable if it was thought that it would be helpful to have some shared processing for each in the lower layers of the backend network 214. This applies not only to a single template footprint 206 with multiple fiducial placement parameters 206, but also to any combination of template footprints 206 and fiducial placement parameters 206. Different instances of placement network 212 might be used for different ensembles of placed footprints as well. This would make sense if it were thought that multiple differently placed objects could exist in close proximity, such as the legs of a horse or parked vehicles in various positions and orientations. When the relative placements can be anticipated in advance, in makes sense to use fiducial placement parameters 206 to represent them; otherwise it may be better to use multiple instances of placement network 212.

Soft logic block 200 also includes a semantic logic layer 250. Semantic logic layer 250 may apply logic 254, provided by an operator, to unstructured predicates 232 (these may be represented as Log its) to produce structured predicates 252. In some examples, semantic logic layer 250 may implement the DASL framework to apply logic 254. One or more of structured predicates 252 may represent a truth value for a presence of a particular pattern in image data, as determined by the soft logic block 200 specified to include and apply a theory, such as a DASL theory. A selection of predicates from unstructured predicates 232 and/or structured predicates 252 are passed through one or more symbolizers 256A-256M that first map the predicates to predicate-like scalars. These feed a loss function 260 for learning. Loss function 260 may be a selected information-theoretic loss function or another type of loss function. In general, each of symbolizers 256 transform real values (e.g., angles) output by a placement network (if these are to be passed into block output channels) into a set of log it values that can be treated like predicate outputs.

Output data 280 can include any one or more of unstructured predicates 232, structured predicates 252, local placement parameters 208, or footprint content 240.

To implement the above, properties and parameters for components of the soft logic block 200 must be specified. These include patchify module 204 and pointify module 202 to implement the grids; template footprint 206, backend network 214 and its architecture, placement network 212 and its architecture and which objects (i.e. backend network 214 channels) they apply to; fiducial placement parameters 216, unstructured predicates 232, and structured predicates 252. Furthermore, the operator may specify which of these layer-internal outputs to use for layer outputs, and which layer output channels to put the layer outputs in. Typically, an operator will specify to output at least structured predicates 252 and some or all of unstructured predicates 232. Some or all of the placement network 212 outputs may be useful to support object descriptions in higher layers. In some circumstances, a higher layer may require some of the footprint inputs to be passed through. The specifications (“specs”) argument to the daslLayer constructor provides, in effect, a compact language for specifying all this information. This is described further in the following daslLayer.py header comment/description:
The input IN is transformed into square patches PCHS of a given edge length and stride by a *patchifier*. The patch center points PNTS are obtained from a closely related *pointifier*.
The patches are input to a *placementNet* that outputs
*local placement parameters* L consisting of any desired combination of
   a 2D local shift vector (Sh),
   a 2D vector of local scaling parameters (Sc),
   a D2 unit vector representation of an angle of rotation (A)
A *footprint* is a [n, 2] tensor of input grid coordinates relative to an origin that is usually chosen to be near their centroid. The coordinates are typically integers but can be real.
A *fidPlacement* is a set of placement parameters like L but do not vary with the patches. They are used to define new footprints in terms of existing footprints by applying the placement transformation.
From a footprint and a fidPlacement one obtains a *kernel builder* KBLDR
that, given PCHS, L and IN, interpolates IN onto the footprint, creating
*footprint content* FPC. This serves as input to a *backendNet* that produces *unstructured predicates* U.
Alternatively one can bypass production of the FPC and take backendNet input directly from PCHS.
Dasl can apply given logic to the unstructured predicates U, represented
as log its, to produce *structured predicates* S. Further logic can be applied involving S to produce more structured predicates.
*****CODE USE AND OPERATION*****
The architecture of the daslLayer is specified by the “specs” argument to the constructor:
specs: [spec, . . . ]
spec: (assemblyTypeName, (constructionSpec, assemblyName_opt, outSpec_opt))
assemblyTypeName: ‘patchify’|‘footprint’|‘L’|‘D’|‘B’|‘B’| |‘U’|‘S’.
         |‘symbolizer’|‘lossSlices’constructionSpec: Custom parameters for each assemblyType.
   ‘patchify’: (k, s, pointifierName)
   ‘footprint’: Argument to builders.py:buildFootprint( )
   ‘L’: spec arg to repositories.py:placementNetRepository.new( )
   ‘D’: ((shH,shW)|None, (scH,scW)|None, a|None)|None//shift, scale, rotate
   ‘B’: spec arg to repositories.py:backendNetRepository.new( )
   ‘C’: spec arg to repositories.py:channelRepository.new( ). See below.
   ‘U’: Unstructured predicate spec. See below
   ‘S’: Structured predicate spec. See below
   ‘symbolizer’: (symzerType, frontendSpec). Args to
   repositories.py:symbolizerRepository.new( )
   ‘lossSlices’: Loss input spec. See below.
assemblyName_opt: Name of assembly instance or name prefix for instances.
outSpec_opt: If and how to map assembly output to layer output channels.
This class holds a set of *Repository classes, one for each assembly type.
Every such repository has a new ( ) method that constructs an object instance from its *spec* argument and assigns it a name. The assigned object may be a nn.Module, dasl macro name, tensor or custom data structure, depending on the repository. The main point of the repositories is to facilitate grabbing the right dasl names for any particular purpose, and to auto-construct a lot of the dasl logic that implements most of the diagram above (FIG. 2).
new( ) has different behaviors in different repositories when the name is already taken:
Raise Exception: patchifierRepository, pointifierRepository,
   footprintRepository, symbolizerRepository, layerRepository
Fetch the macro: placementRepository, KbuilderRepository,
   footprintContentRepository
Augment a group: placementNetRepository, fidPlacementRepository,
   backendNetRepository, channelRepository,
   unstructuredPredicateRepository, structuredPredicateRepository
The repositories have a facility for managing named groups of instances,
basically with named sequences of instance names.
“Augment a group” means:
Form a group name by prepending ‘G’ to the instance name. (Instance names starting with ‘G’ are prohibited.) If there is no group with that name, create one and put the instance in it, with ‘_0’ appended to the instance name. If there is such a group, put the new instance in it with f‘_{i}’ appended, where i is the smallest non-colliding positive integer.
This group behavior means that for these 4 types, repeated specs with the same name have the effect of forming groups. One can therefore use the idiom
*n* [(assemblyTypeName, [(constructionSpec, assemblyName, outSpec_opt)])]
in the specs list to create a named group of n instances. This is
the recommended method for creating groups of placementNets, fidPlacements, and backendNets, but not for channels, unstructured predicates or structured predicates. The constructionSpecs for the latter can contain group names of the former that are used in assemblyType-specific ways to create groups of the latter.
The constructionSpec for ‘C’ has the form: (Bname|GBname, iC|(iC, . . . )), where Bname is a backendNet name, GBname is a backendNet group name, iC is an output index and (ic, . . . ) is a tuple of distinct indices. This spec results in a group of channels containing a member for every distinct (Bname, iC) pair, in the order
(B0,C0), (B0,C1), . . . (B1,C0), (B1,C1), . . . .
The specs for ‘U’ and ‘S’ employ the named groups to help specify which logic applies to which predicates. An unstructured predicate is specified by its channel (which knows it's backendNet which knows its footprint), placementNet, fidPlacement, patchifier, pointifier and layer input. The ‘U’ constructionSpec has the form:
(chan|(chan, tag), pln|(pln, tag), fid|(fid, tag), pfr, ptr, Lin),
of which the last 3 are required only in the unusual situation that there
is more than one patchifier, pointifier, or input layer in question.
Here ‘chan’, ‘pln’ and ‘fid’ are channel, placementNet, and fidPlacement
group names, respectively. (The initial ‘G’ is optional.) ‘tag’
is an arbitrary string such as ‘i’, ‘il’, etc. When present, matching
tags are expected to be paired with groups of the same size, and indicate
that the tagged groups are to be ‘zipped’ together. The absence of a tag can be thought of as the presence of an implicit tag distinct from all the others. The group of unstructured predicates defined by the spec contains the predicates defined by all possible combinations of group members, except that only corresponding members of like-tagged
groups enter into the combination rather than all possible combinations.
Structured predicates are generated by choosing a *logicMotif* supported
by repositories.py:structuredPredicateRepository.new( ), and supplying named groups of unstructured or structured predicates as arguments.
Groups of structured predicates are formed by the same name manipulation
conventions as for unstructured predicates, and kept in the structuredPredicateRepository. The code looks for group names in the unstructuredPredicateRepository first, then the structuredPredicateRepository.

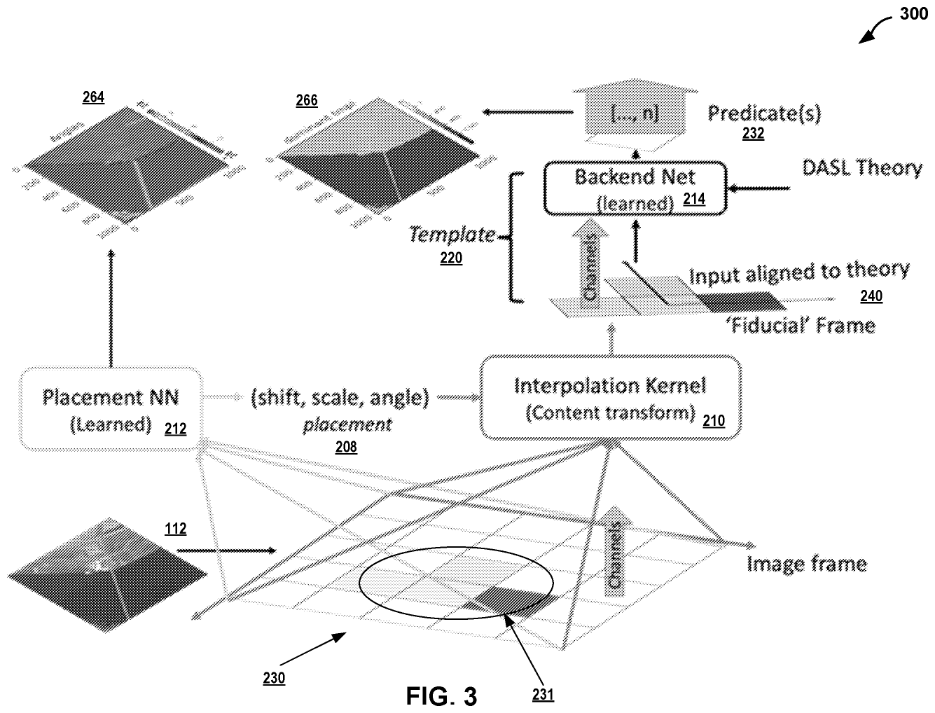

FIG. 3 is a conceptual diagram depicting components and operation of an example soft logic block, according to techniques of this disclosure. Soft logic block 300 may represent any of soft logic blocks 160 or another soft logic block described in this disclosure.

In this example, soft logic block 300 generates, from an input image frame 112, a grid of patches centered on interest points. The grid of patches is imposed on input image 112. A 5-pixel×5-pixel patch 230 is shown in FIG. 3. Based on the content of each patch, placement network 212 outputs a local placement parameters 208 including one or more of a patch-local shift vector, scale vector, or rotation vector to apply to footprints in patch 230, of which one footprint 231 is shown as 4 pixels. (There can be multiple footprints, and different instances of placement network 212 can apply to different ones.) The footprint 231 is placed accordingly, and the image content therein is interpolated onto footprint 231, for instance with a bilinear interpolation kernel 210. In some examples, fiducial placement transformations may be applied (not shown), within the transformed frame of reference of a footprint to describe an arrangement of object parts relative to each other (i.e., without reference to the image frame). One or more backend networks 214 are applied to the fiducially placed footprints to produce an ensemble of binomial parameters for unstructured predicates 232, each being one or more probability values representing the probability of some (possibly anonymous) predicate holding true. One or more of the predicates may provide a likelihood that a particular pattern is present in the footprint. This is a two-stage process (not shown) beginning with a mapping from the footprint content to unstructured predicates, followed by hand-authored logical operations that convert these to structured predicates, for instance using DASL. Unstructured predicates 232 may be binomial parameters (soft bits) computed from the content of locally and fiducially placed footprints, and they are suitable for input to logic, which may be DASL logic. Structured predicates 252 may include logic 254 expressed in terms of unstructured predicates and/or other structured predicates. In some examples (shown in FIG. 2), a symbolizer network may transform the placement parameters into additional predicates. A selection of predicates is passed to an unsupervised loss function to train the model. Logic 254 may be automatically generated to describe complex patterns from shorter specifications.

### Unsupervised Training Loss

Unsupervised learning is carried out by maximizing the mutual information objective IΦD defined by equation (8) in Richard Rohwer, “Logic and Information in Unsupervised Learning,” included in U.S. Provisional Application No. 63/301,444 incorporated by reference herein in its entirety. This loss expresses the amount of information from the data D captured by a given set of structured and/or unstructured predicates Φ. The specs argument to the daslLayer constructor provides a way to specify which predicates, among those copied to the output, are to be included in Φ. It is important also to include the placementNet parameters in Φ. This is what drives the attention mechanism to disincentivize the predicates from capturing placement information. However, the placement parameters cannot be treated as predicates because they are not distribution valued. Therefore, a learned mapping is introduced from the placement parameters to a specified number of binomial parameters that are treated like the predicates. Each such mapping is referred to as a “symbolizer,” and its details are also specified in the specs argument to the daslLayer constructor. A symbolizer maps continuous parameters into a set of binomial parameters that are combined with unstructured and/or structured predicates as input to an information-theoretic objective function in order to co-adapt the predicates and the attention to placement.

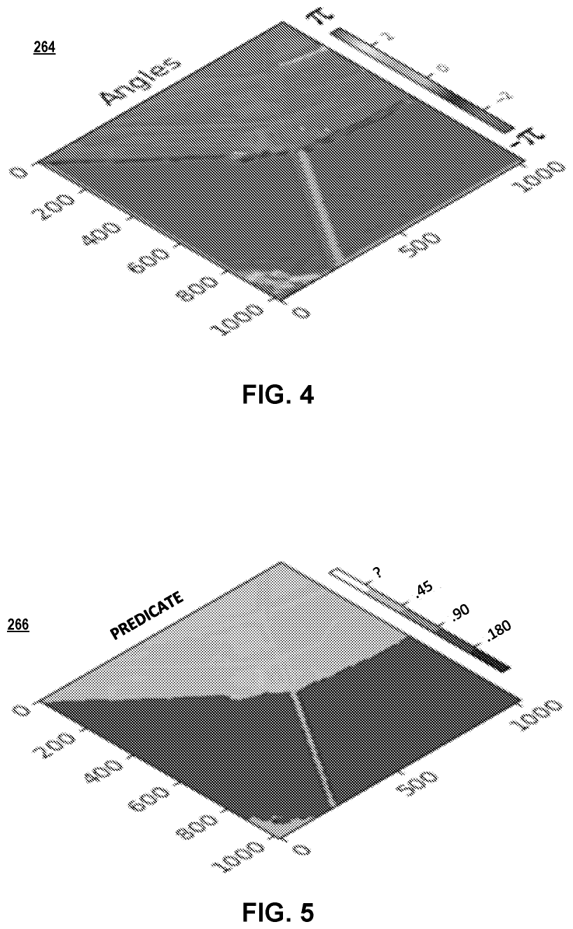

FIG. 4 illustrates, in further detail, chart 264 of FIG. 3. Chart 264 may be generated from local placement parameters 208 for various patches of the grid of patches for input image 112, the local placement parameters 208 being generated by placement network 212. Chart 264 shows the rotation angle at each patch of a 1000×1000 grid of patches.

FIG. 5 illustrates, in further detail, chart 266 of FIG. 3. Chart 266 may be generated from and represent one or more of unstructured predicates 232 generated by backend network 214.

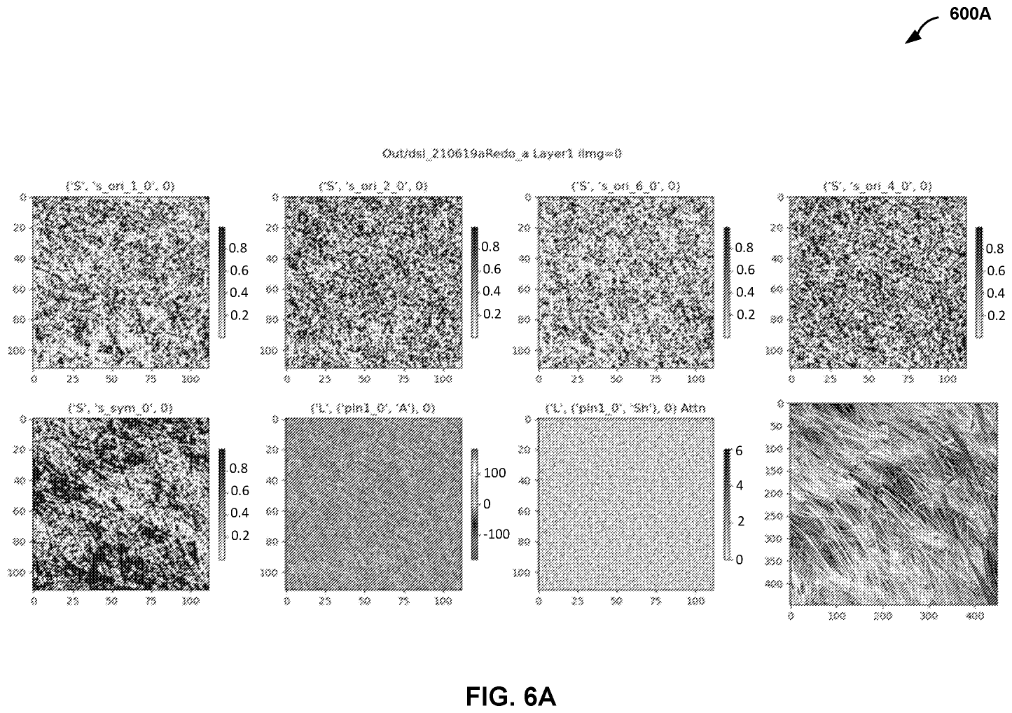

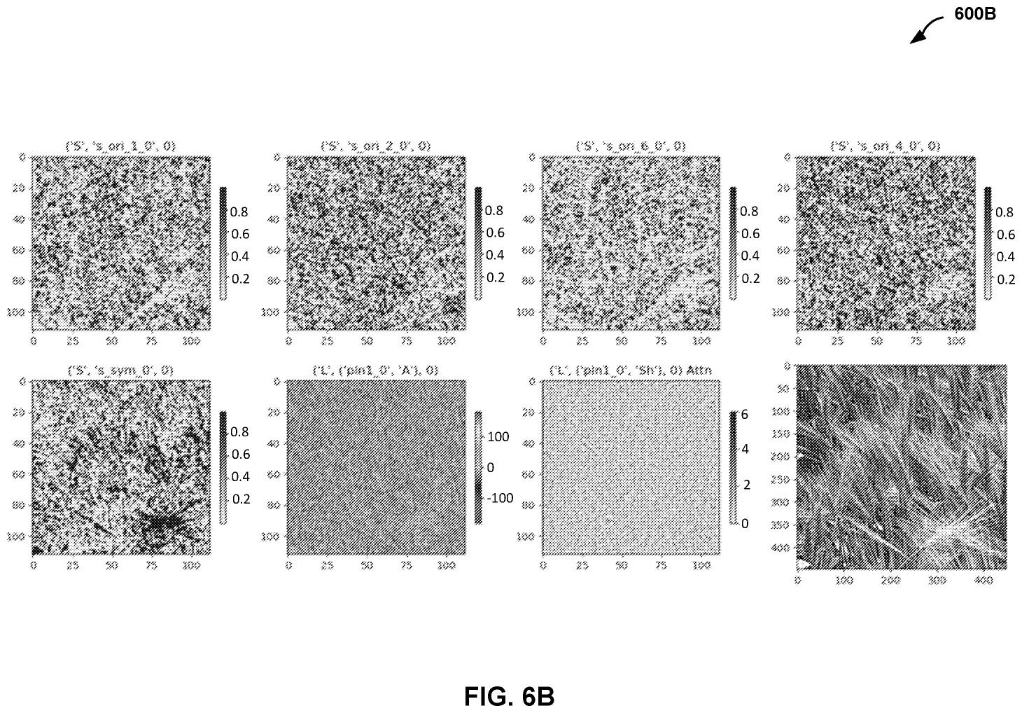

FIGS. 6A-6B illustrate sample outputs of a visual description network from images of hail damaged wheat (FIG. 6A) and healthy wheat (FIG. 6B). The visual description network distinguished images hail-damaged wheat from healthy wheat without training on labeled data. The visual description network was generated from daslLayer code, as documented elsewhere herein.

The network has two soft logic blocks. The first soft logic block maps the 3 RGB channels into 8 anonymous features. The thought is that part of the work is simply to interpret the colors in a more explicitly problem-relevant way, and that much of this work can be done in the same way for every pixel. This is easy to do directly in pytorch, but also constitutes an easy first example for doing the same thing with a soft logic block. The code is shown in Code Snippet 1.

Code Snippet 1:

```
# 1×1 convolution mapping 3 colors to 8 channels
nC1=8
[ (′patchify′, ( (1, 1, ′pchr_1×1′), ′pointr_1x1′) ) ,
  (′footprint′, ( ( ′patch′, 1, 1), ′fp_1×1′) ) ,
  (′B′, ( (′lin′, ′fp_1×1′, 3, nC1) , ′GbakA′) ) ,
  * [ ( ′C′, ( ( ′GbakA′, i) , ′bakA_C′ ) ) for i in range (nC1) ],
  (′U′, ( ( ′GbakA_C′, None, None) , ′uA′, True) ) ]
```

Code Snippet 1 defines a daslLayer constructor spec for first layer. The ‘patchify’ line places functions called ‘pchr_1×1’ and ‘pointr_1×1’ in the DASL model. pchr_1×1 breaks the image into 1-pixel patches, and pointr_1×1 (trivially) indexes the center of those patches. Because no placementNet is used, pchr_1×1 goes unused. The ‘footprint’ line creates a 1-pixel footprint called ‘fp_1×1’ which is used in the ‘B’ line to define the input to a linear backendNet with 3 inputs and 8 outputs. This backendNet is named ‘bakA’, and is placed into a 1-member group called ‘GbakA’. The ‘*’ in front of the ‘C’ line expands it into 8 lines, each distinguished by a consecutive value of i. The first of these lines creates a group of channels called ‘GbakA_C’, and each remaining line adds a member to the group. The channels are just names for the 8 outputs of ‘bakA’, the sole member of ‘GbakA’. Had there been more, names would have been generated for all. The final ‘U’ line creates a group of 8 unstructured predicates called ‘GuA’, one for each channel in ‘GbakA C’. The final ‘True’ flag states that these predicates are to appear in the daslLayer output.

Printing the resulting DASL Model shows the parse tree of the logic and the implementation of each entity, function or predicate that can appear on its nodes. Some of the generated logic is shown in Code Snippet 3.

Code Snippet 3:

1 fp_1×1_None_None_L0_pointr_1×1 pchr_1×1 =
flattenPatch (pointr_1×1 (L0) )
2 uA_0 = idx0 (bakA_0
(fp_1×1_None_None_L0_pointr_1×1_pchr_1×1) )
3 uA_1 = idx1 (bakA_0
(fp_1×1_None_None_L0_pointr_1×1_pchr_1×1) )
. . .
8 uA_6 = idx6 (bakA_0
(fp_1×1_None_None_L0_pointr_1×1_pchr_1×1) )
9 uA_7 = idx7 (bakA_0
(fp_1×1_None_None_L0_pointr_1×1_pchr_1×1) )
L1 = D2C (cat
(uA_0, uA_1, uA_2, uA_3, uA_4, uA_5, uA_6, uA_7) )

In Code Snippet 3, some of the logic is produced from the code of Code Snippet 1. ‘L0’ and ‘L1’ are the names of the input and output, respectively. It can be seen that the DASL Model functions pointr_1×1 and bakA_0 (the sole member of GbakA) appear. The remaining functions, ‘flattenPatch’, ‘idx0’, . . . , ‘idx7’, ‘cat’, and ‘D2C’ are placed in the DASL model by daslLayer code. The ‘L1’ line concatenates the unstructured predicates and performs a dimension permutation to produce the layer output.

The second soft logic block is specified as shown in Code Snippet 2, and some of its auto-generated logic in Code Snippet 4. The ‘patchify’ line specifies 11×11 patches with stride 4, and the ‘footprint’ line specifies a 3×9 footprint called ‘fp_3×9’. The ‘L’ line specifies a placementNet that accepts 11×11 input with nCl-8 channels and has outputs for angles (always assumed) and shifts of up to 3 pixels, but no scaling. It is an multilayer perceptron (MLP) with 2 layers as specified by nH_L, and is called ‘pln1’. The ‘True’ flag indicates that its output is to appear in the daslLayer output. The ‘D’ line specifies a group of fiducial placements called ‘fidA’ at equally spaced angles with no shift and no scaling. The ‘B’ lines define two backendNets one called ‘bak_ori8’ that will be used to detect oriented patterns and one called ‘bak_sym8’ to detect rotationally symmetric patterns. They are linear networks that map the fp_3×9 footprint with 8 channels to 4 outputs in the case of bak_ori8, and 1 output for bak_sym8. These outputs are given names by the two ‘C’ lines. The first ‘U’ line creates 4 groups of 8 unstructured predicates, one group for each output channel of bak_ori8 and with a group member for each of the 8 fiducial placements in fidA. The second ‘U’ line creates a single such group for the single output of bak_sym8. Each of the 5 ‘S’ lines creates a structured predicate from one of these 5 groups of 8 unstructured predicates. Each is defined as a conjunction with some of the conjuncts negated according to the given patterns of positive and negative 1's. Each of these 5 structured predicates says, essentially, that the corresponding channel of bak_ori8 or bak_sym8 gives a high value at some angles and a low value at others, according to the given pattern. Thus, s_ori_1 responds very specifically at one angle but at none of the others (after local shift and rotation by pln1). s_ori_2 responds at 2 angles 180° apart. s_ori_6 responds to anything outside a 90° wedge, and s_ori_4 responds to a half-plane. s_sym responds equally to all orientations; it is rotationally symmetric. All 5 of these predicates are presented as daslLayer output.

The final lines set up the loss function. The predicates are outputs of a linear network, so they can have any real value. These values are mapped to the [0, 1] legal range of binomial parameters by a symbolizer called ‘psymzer’, which, one finds upon digging into definitions in the DASL model (not shown) is essentially just a sigmoid. The local angles are represented as unit vectors when output by pln1. These are mapped to nAsym=6 binomial parameters by another symbolizer called ‘asymzer’ that consists of a small neural net with sigmoidal output. The ‘A’ in the final line selects angles. It would make sense to also include the shifts, but that was not done here. Iloss5 refers to the IΦD information objective.

Portions of the resulting DASL logic are shown in Code Snippet 4. The input L1 is mapped to output L2. The shifts and angles are produced by the placementNet in lines 1 and 2. The locally and fiducially placed footprint contents are then defined in lines 3, 5, . . . , 17. These are input to bak_ori8_0, the sole backendNet in group Gbak_ori8, to define all the unstructured predicates in the remaining lines up to 45. The u_sym predicates are obtained similarly in lines 47 to 54. The structured predicates are then defined in lines 56 to 60, and the output in line 61.

Code Snippet 2:

| | |
|---|---|
| nC1=8 | # Number of input channels from layer 1 output |
| k1=11 | # Patch width and height for |
| | placementNet input |
| s1=4 | # Stride for patches and center points (interest |

points)

| | |
|---|---|
| shmx=3.0 | # How far footprint can shift in any direction |

from its interest point

| | |
|---|---|
| s cmn=None; scmx=None | # Do not allow scale factor adjustment |
| nP=4 | # Number of ′oriented′ predicates |
| nAsym=6 | # Angles mapped into this many ′symbols′ |

binomial parameters)

| | |
|---|---|
| pFlip=0.25. | # Bit flip probability (Helps avoid local optima) |
| nH_L=(128, 32) | # placementNet has 2 hidden layers, 128 and 32 |
| nodes | |

```
[(′patchify′, ((k1, s1, ′pointr_11′), ′pchr_11′) ),
  (′footprint′, ((′oddbox′, 3, 9), ′fp_3×9′)),
  (′L′, ((′pn_basic3′, k1, nC1, shmx, scmn, scmx, nH_L), ′pln1′, True) ),
  (′D′, ( (′eqAngles′, 8), ′fidA′) ),
  (′B′, ( (′lin′, ′fp_3×9′, nC1, nP), ′bak_ori8′) ),
  * [ (′C′, ( (′Gbak_ori8′, i), f′back_ori8_C_{i}′) )_for i in range (nP) ],
  (′B′, ( (′lin′, ′fp_3×9′, nC1,1), ′bak_sym8′) ),
  (′C′, ( (′Gbak_sym8′, 0), ′bak_sym8_C′) ),
  * [ (′U′, ( (′f′Gbak_ori8_C_{i}′, ′pln1′, ′fidA′),_f′u_ori_{i}′, False) ) for i
in range (nP) ],
  (′U′, ( (′Gbak_sym8_C′, ′pln1′, ′fidA′), ′u_sym′, False) ),
  (′S′, ( ( (motif′, ′conjWithNegPattern′, (1, −1,−1,−1,−1,−1,−1,−1,) ),
(′U′, ( (′G_ori_0′, ) ),
    ′s_ori_1′, True) ),
  (′S′, ( ( (′motif′, ′conjWithNegPattern′, (1, −1,−1,−1,−1,−1,−1,−1,) ),
(′U′, ( (′G_ori_1′, ) ),
    ′s_ori_2′, True) ),
  (′S′, ( ( (′motif′, ′conjWithNegPattern′, (1,1,−1,−1,1,1,1,1,) ),
(′U′, ( (′G_ori_2′, ) ),
    ′s_ori_6′, True) ),
  (′S′, ( ( (′motif′, ′conjWithNegPattern′, (1,1,1,1,−1,−1,−1,−1,) ),
(′U′, ( (′Gu_ori_3, ) ),
    ′s_ori_4′, True) ),
  (′S′, ( ( (′motif′, ′conjWithNegPattern′,
(1,1,1,1,1,1,1,1,) ), (′U′, ′Gu_sym′) ), ′s_sym′, True) ),
  ( ′smybolizer′, ( (′flipBits′, (′pFlip′, pFlip) ), ′pSymzer′),
  ( ′smybolizer′, ( (′flipBits′, (′pFlip′, pFlip) ), ′lin′, 2, nAsym) ),
′aSymzer′) ),
  (′lossSlices′, ( ( (′Iloss5′,
      (′S′, ′Gs_ori_1′, ′pSymzer′),
      (′S′, ′Gs_ori_2′, ′pSymzer′),
      (′S′, ′Gs_ori_6′, ′pSymzer′),
      (′S′, ′Gs_ori_4′, ′pSymzer′),
      (′S′, ′Gs_sym′, ′pSymzer′),
      (′L′, ′A′, ′Gpln1′, ′aSymzer′) ) ,),) ) ]
```

Code Snippet 2 shows a daslLayer constructor spec for layer 2.

Code Snippet 4:

```
1 Sh0 = pln1_0(pchr_11(L1))[0]
2 A0 = pln1_0(pchr_11(L1))[1]
3 fp_3x9_pln1_0_fidA_0_L1_pchr_11_pointr_11 = fp_3x9_fidA_0_ShA(L1,
pointr_11(L1), Sh0, A0)
4 u_ori_0_0 = idx0(bak_ori8_0(fp_3x9_plm1_0_fidA_0_L1_pchr_11_pointr_11))
5 fp_3x9_pln1_0_fidA_45_L1_pchr_11_pointr_11 = fp_3x9_fidA_45_ShA(L1,
pointr_11(L1), Sh0,A0)
6 u_ori_0_1 = idx0(bak_ori8_0(fp_3x9_pln1_0_fidA_45_L1_pchr_11_pointr_11))
. . .
17 fp_3x9_pln1_0_fidA_315_L1_pchr_11_pointr_11 = fp_3x9_fidA_315_ShA(L1,
pointr_11(L1), Sh0,A0)
18 u_ori_0_7 =
idx0(bak_ori8_0(fp_3x9_pln1_0_fidA_315_L1_pchr_11_pointr_11))
20 u_ori_1_0 = idx1(bak_ori8_0(fp_3x9_pln1_0_fidA_0_L1_pchr_11_pointr_11))
21 u_ori_1_1 = idx1(bak_ori8_0(fp_3x9_pln1_0_fidA_45_L1_pchr_11_pointr_11))
. . .
27 u_ori_1_7 =
idx1(bak_ori8_0(fp_3x9_pln1_0_fidA_315_L1_pchr_11_pointr_11))
29 u_ori_2_0 = idx2(bak_ori8_0(fp_3x9_pln1_0_fidA_0_L1_pchr_11_pointr_11))
. . .
36 u_ori_2_7 =
idx2(bak_ori8_0(fp_3x9_pln1_0_fidA_315_L1_pchr_11_pointr_11))
. . .
45 u_ori_3_7 =
idx3(bak_ori8_0(fp_3x9_pln1_0_fidA_315_L1_pchr_7x7_pointr_7x7))
47 u_sym_0 = idx0(bak_sym8_0(fp_3x9_pln1_0_fidA_0_L1_pchr_11_pointr_11))
48 u_sym_1 = idx0(bak_sym8_0(fp_3x9_pln1_0_fidA_45_L1_pchr_11_pointr_11))
. . .
54 u_sym_7 = idx0(bak_sym8_0(fp_3x9_pln1_0_fidA_315_L1_pchr_11_pointr_11))
56 s_ori_1_0 = ((u_ori_0_0) & (~u_ori_0_1) & (~u_ori_0_2) & (~u_ori_0_3) &
(~u_ori_0_4) &
  (~u_ori_0_5) & (~u_ori_0_6) & (~u_ori_0_7))
57 s_ori_2_0 = ((u_ori_1_0) & (~u_ori_1_1) & (~u_ori_1_2) & (~u_ori_1_3) &
  (u_ori_1_4) &
(~u_ori_1_5) & (~u_ori_1_6) & (~u_ori_1_7))
58 s_ori_6_0 = ((u_ori_2_0) & (u_ori_2_1) & (~u_ori_2_2) & (~u_ori_2_3) &
(u ori_2_4) &
  (u_ori_2_5) & (u_ori_2_6) & (u_ori_2_7))
59 s_ori_4_0 = ((u_ori_3_0) & (u_ori_3_1) & (u_ori_3_2) & (u_ori_3_3) &
(~u_ori_3_4) &
  (~u_ori_3_5) & (~u_ori_3_6) & (~u_ori_3_7))
60 s_sym_0 = ((u_sym_0) & (u_sym_1) & (u_sym_2) & (u_sym_3) & (u_sym_4) &
(u_sym_5) &
  (u_sym_6) & (u_sym_7))
61 L2 = cat(s_ori_1_0,s_ori_2_0,s_ori_6_0, s_ori_4_0, s_sym_0, Sh0, A0)
```

Code Snippet 4 shows some of the logic produced by the code in Code Snippet 2.

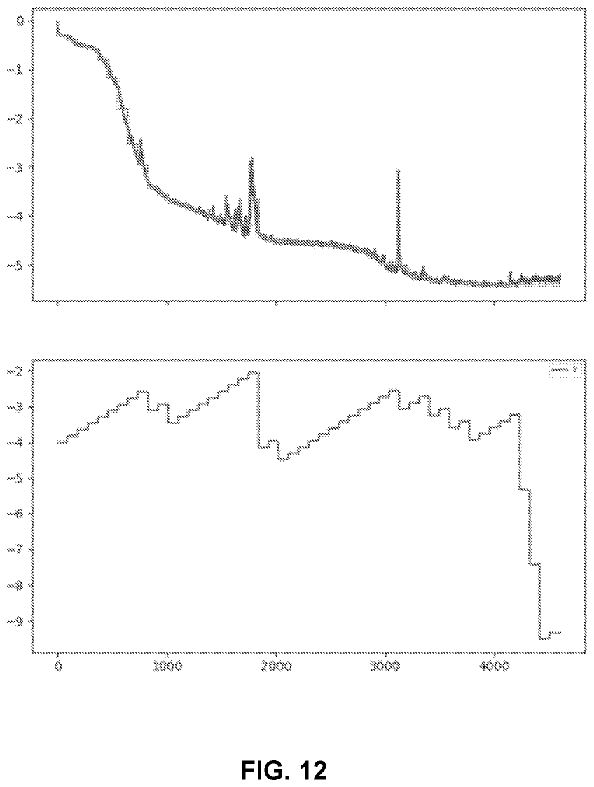

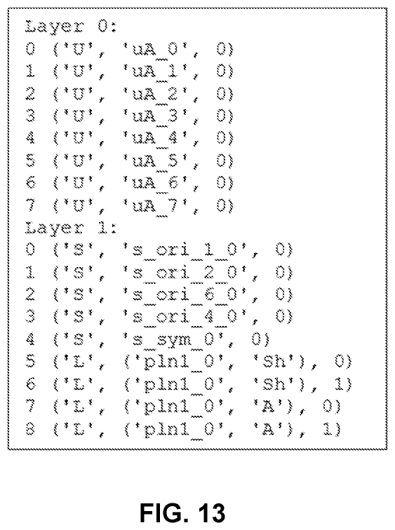

There is a legend field that keeps track of what is in each output channel of each layer. An example output legend is shown in FIG. 13. Multi-variate outputs such as shift and angle (a unit vector) occupy multiple channels, as indicated by the final integer in the tuples. This model was trained for about an hour, achieving a mutual information value of about 5.4. The learning curve is shown in FIG. 12. The Cost is −IΦD; hence the negative numbers in the top panel which shows batch-wise costs in blue, smoothed in orange. A complex adaptive step size algorithm was used. A log 10 of the step size is shown in the lower panel of FIG. 12.

FIG. 6A shows output from an image of hail damaged wheat, and FIG. 6B shows output from an image of healthy wheat. For each set, the four oriented predicates are along the top row. The bottom row shows the symmetric predicate, the local placement angles, local shifts and original image, respectively. First, it can be noted that the shifts appear random, which is reasonable. The sweep of the stems can be seen in the local angles, especially for the hail damaged case. From the images, the healthy wheat shows prominent kernels whereas the hail damaged wheat shows more stems.

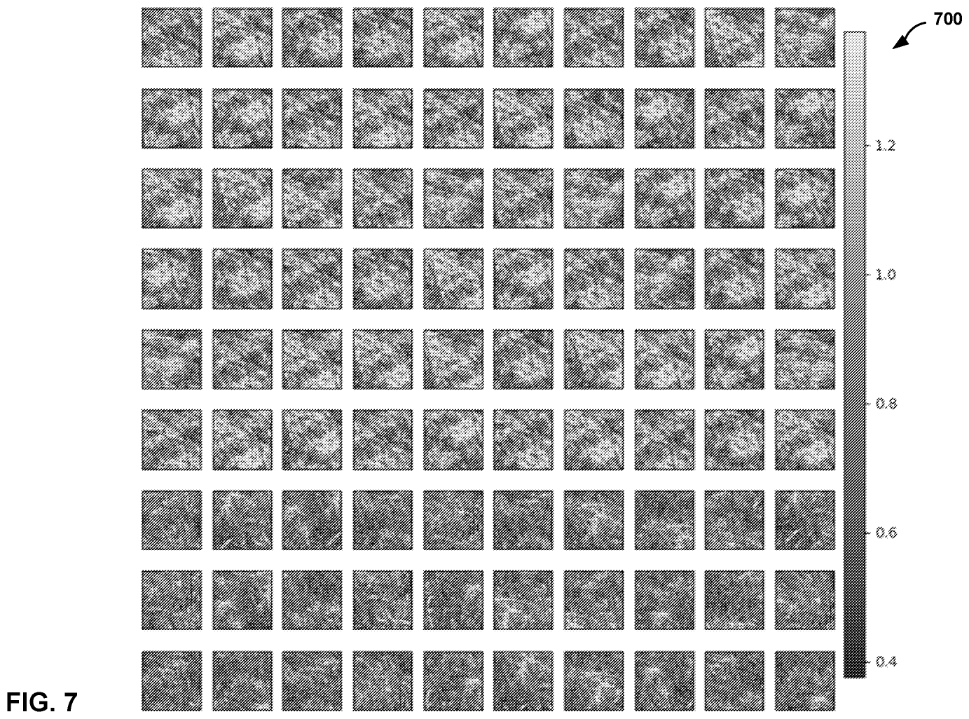

Looking at the predicates, the most obvious difference is in the symmetric predicate. It looks stronger (more dark regions) for damaged wheat than for healthy wheat. This is the opposite of what would be expected if the healthy wheat shows more symmetry due to exhibiting fewer stems. But then, the mutual information objective is symmetric under exchange of True and False (or rather, p and 1-p), so this predicate may have been inverted. Perhaps some of the oriented predicates are inverted too, but they appear random so it is difficult to tell. Considering this hypothesis, the symmetric predicate may be subtracted from the mean of the oriented predicates, on the understanding that this will produce smaller numbers for the more symmetric healthy wheat than for the less symmetric damaged wheat. But the symmetric predicate must be inverted first, so in effect, these are added. The result of this operation is shown in FIG. 7, which uses a different colorbar in which the darker regions have smaller values. The damaged wheat is in the top 6 rows (more lighter/larger values) and the healthy wheat in the bottom 3 rows (more darker/smaller values), confirming the hypothesis.

The validity of these hypotheses/intuitions is debatable, but the conclusion is not. It is also clear that if instead these predicates were used as input to supervised learning with a very small number of labeled examples, the desired result would still have been obtained. Either way, this modest amount of reasoning or labeling represents the human effort required for data inspection.

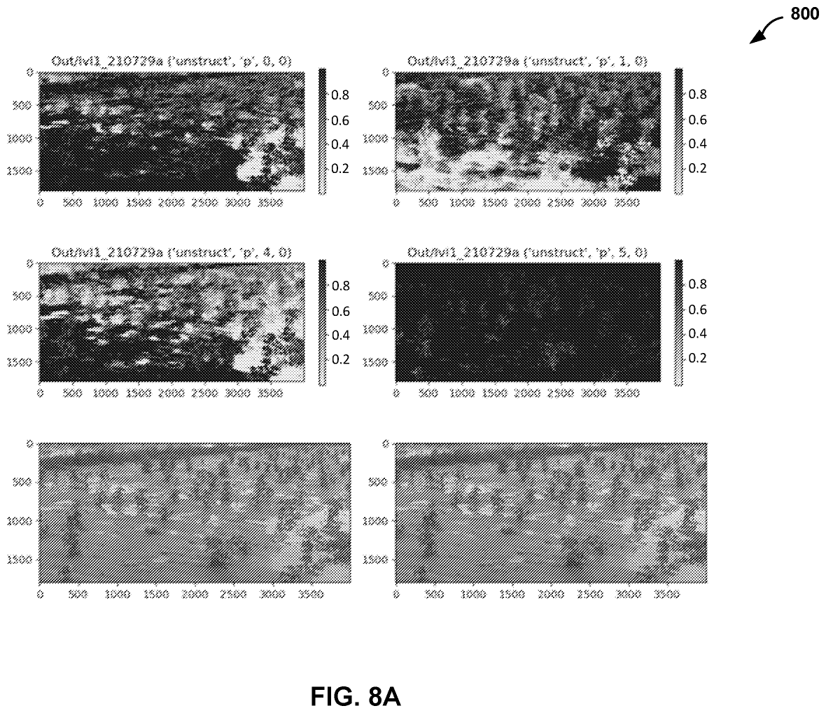

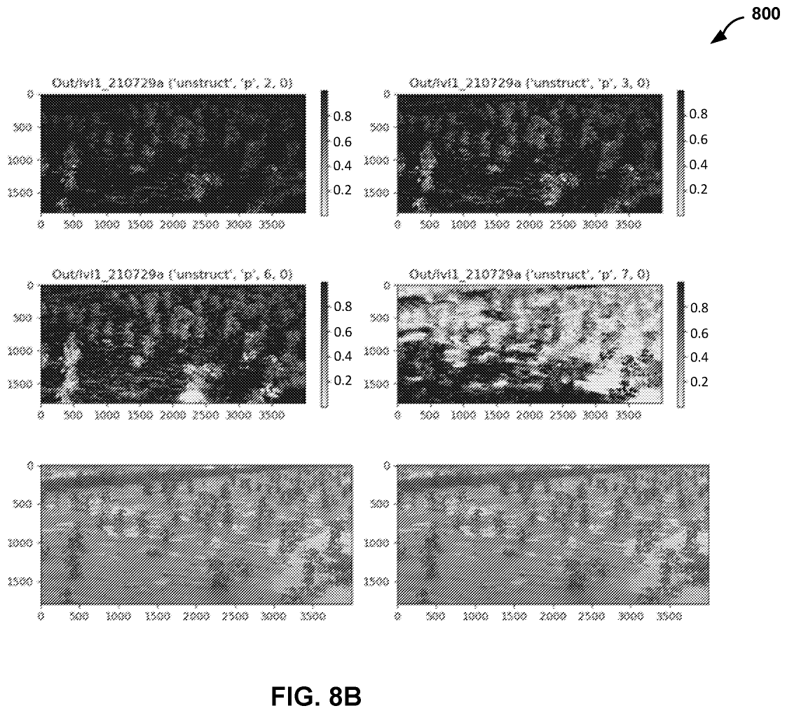

A simpler model may have sufficed. Variations of this model have not been seriously explored. There is anecdotal evidence that much can be done with unstructured predicates alone. FIGS. 8A-8B, for example, shows results from training 8 unstructured predicates with neither local nor fiducial placements. Predicates 0 and 4 do a plausible job of distinguishing water from mud, which happened to be a problem of interest. (The initial 1×1 convolution from 3 to 8 channels was used in this case as well.)

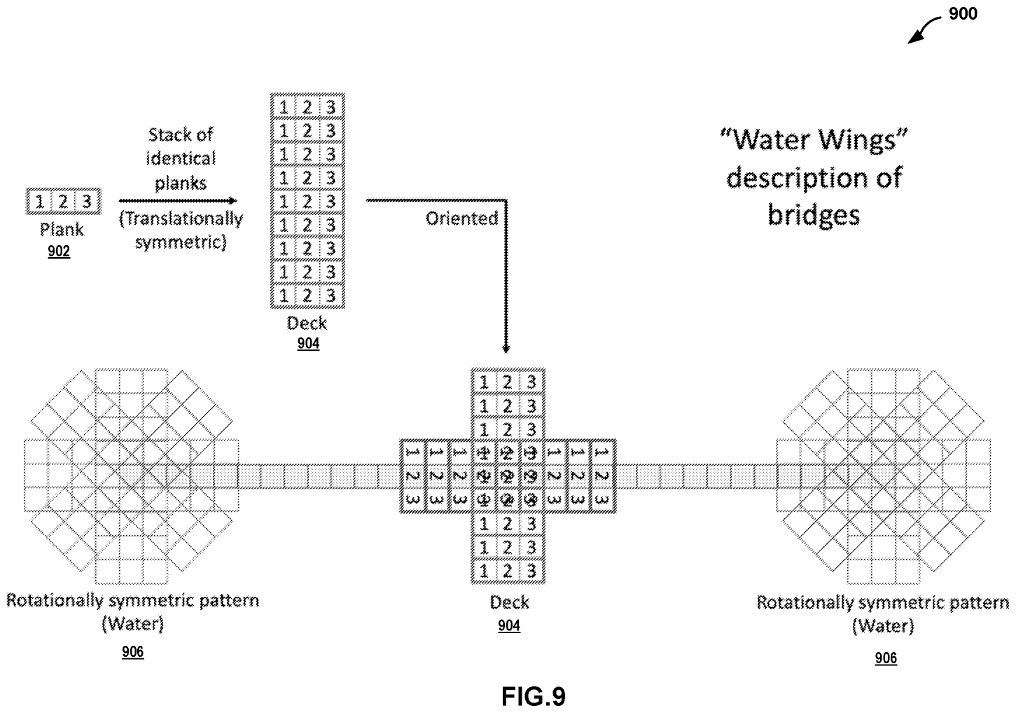

FIG. 9 depicts a representation of a visual description 900 of bridges, in accordance with techniques of this disclosure. The characteristics of bridges, or “bridgeness”, is described as a long narrow oriented pattern (the bridge itself) with symmetric patterns on either side (the water), as illustrated in FIG. 9. There are many possible ways to define the details, but this description used to generate a soft logic block, was modestly successful and serves well as an illustrative exercise. In FIG. 9, bridge deck 904 is represented as an oriented stack of identical “planks” 902. Water is represented by rotationally invariant patterns 906 on either side of the deck.

A visual description network may be created incorporating a visual description created according to techniques of this disclosure, to detect bridges in images. The visual description network was generated from daslLayer code, as documented elsewhere herein.

In this example, there were 16 1024×1024 training images. First, a two-layer pre-processing network described by the daslLayer code in Code Snippet 5 was trained by unsupervised learning. The network architecture is very similar to that used in the previous example, so no further explanation is given here. Also, the same IΦD cost function was used. Training was carried out for 29 minutes to achieve 1.958 bits of information, and then for a further 2.5 hours at a lower initial learning rate, improving this figure negligibly to 1.963. The output consists of 4 unstructured predicates, local shifts and local angles. These were average-pooled with a 7×7 kernel at a stride of 4, bringing the images down to 256×256.

Code Snippet 5

```
k1=7; s1=3; nC1=8; nP=4; nAsym=6; nH_L = (64, ) ; nH_B = (128, 64)
pFlip=0.25; s1=16; shmx=3.0
specs0 = [ # 1×1 convolution mapping 3 colors to 8 channels
  ( ′patchify′, ( (1, 1, ′pchr_1×1′), ′pointr_1×1′) ),
  (′footprint′, ( ( ′patch′, 1, 1), ′fp_1×1′) ),
  (′B′, ( (′lin′, ′fp_1×1′, 3, nC1) , ′GbakA′ ) ) ,
  * [ (′C′, ( (′GbakA′, i) , ′bakA_C′) ) for i in range (nC1) ],
  (′U′, ( (′GbakA, i), None, None) , ′uA′, True) ) ]
specs1=[ # 4 unstructured features of 7×7 patches with learned rotations
  ( ′patchify′, ( (k1, s1, ′pointr 7×7′), ′pchr_7×7′) ) ,
  (′footprint′, ( (′oddbox′, k1, k1), ′fp_7×7′) ) ,
  (′L′, ( (′pn_basic3′, k1, nC1, shmx, None, None, nH_L) , ′pln1′, True) ) ,
  (′B′, ( (′simpleMLP′, ′fp_7×7′, nC1, nP, nH_B, False) , ′bak1′ ) ) ,
  *[ (′C′, ( (′Gbak1′, i) , ′bak1_C′) ) for i in range (nP) ] ,
  (′U′, ( (′Gbak1_C′, ′pln1′, None), ′u1′, True) ) ,
  ( ′symbolizer′, ( (′flipBits′, (′pFlip′, pFlip) ) , ′pSymzer′ ) ) ,
  (′symbolizer′, ( (′flipBits′, (′pFlip′, pFlip, ′lin′, 2, nAsym) ) ,
′aSymzer′ ) ) ,
  ( ′lossSlices′, ( ( (′Iloss5′,
    (′U′, ′Gu1′, ′pSymzer′) ,
    (′L′, ′A′, ′Gpln1′, ′aSymzer′ ) ) , ) , ) ) ]
```

Code Snippet 5 is an example daslLayer spec for a 2-layer pre-processing network.

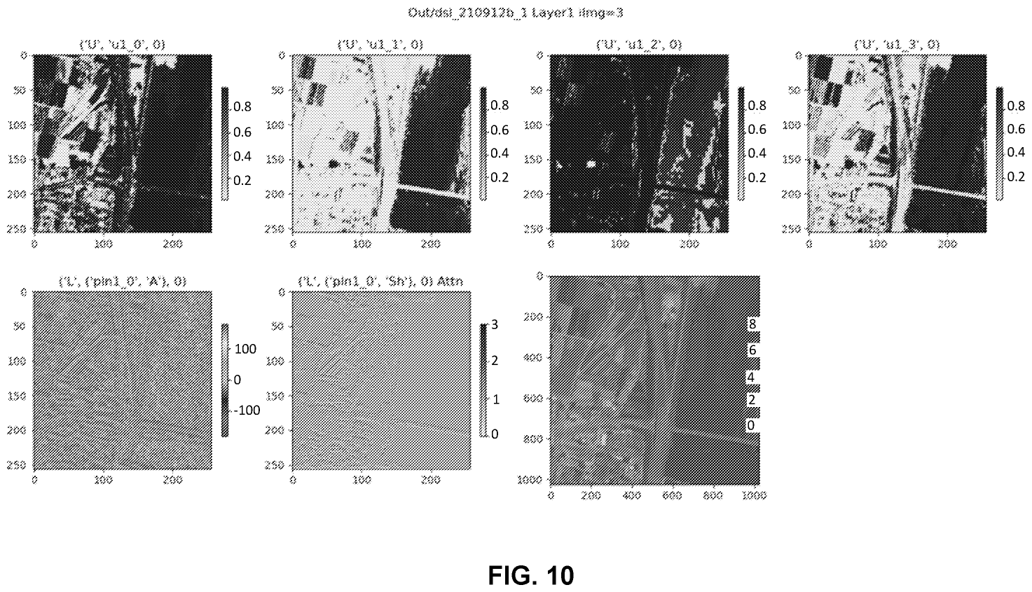

Example output of the pre-processing network is shown in FIG. 10. It can be seen that aside from some correlation between predicates 1 and 3, the 4 predicates seem reasonably uncorrelated, as one would expect with an information capture objective. Also of note are the relatively random angles in the water and more structured angles along the bridge, roads and buildings seen in the A chart (bottom row, left-most).

The preprocessing output was fed to a network defined by the daslLayer constructor spec shown in Code Snippet 8, which refers to partial specs in Code Snippet 6 and Code Snippet 7, and implements visual description 900 illustrated by FIG. 9. Code Snippet 6 implements the deck and Code Snippet 7 implements the water.

Code Snippet 6:

```
def specs_sH (nA=2, aRange=180, hs=9, ws=3, Cin=4) :
  ″″″
  One vertical stack of hs identical 1xws features. Stack is rotated
  nA ways. Predicate is to be true at one angle and false in all others.
  ″″″
  dA = aRange/nA
  a8 = [ (dA*i if dA*i<180 else dA*i−360) for i in range (nA) ]
  a8nm = [f′ { round (dA*i) }′ for i in range (nA) ]
  return [
    ( ′footprint′, ( (′oddbox′, 1, ws) , ′boxH′ ) ) ,
    * [ (′D′, ( (′stackedBars′, hs, a8[i] ) , f′fidH_{a8nm[i] } ′ ) ) for i in
range (nA) ] ,
    (′B′, ( (′simpleMLP′, ′boxH′, Cin, 1, 16) , ′GbakH′ ) ) ,
    (′C′, ( (′GbakH′, 0), ′bakH_C′ ) ) ,
    * [ (′U′, ( (′GbakH_C′, ′pln′, f′GfidH_{a8nm[i] } ′ ) ,
f′uH_{a8nm[i] } ′, False) )
      for i in range (nA) ] ,
    *[ (′S′, ( ( ( ′motif′, ′conjWithNegPattern′, hs* (1, ) ) ,
        (′U′, f′GuH_{a8nm[i] } ′ ) ) , ′sHA′, False) ) for i in
range (nA) ] ,
    (′S′, ( ( (′motif′, ′conjWithNegPattern′, (1, ) + (nA−1) *(0, ) ) ,
      (′S′, ′GsHA′ ) ) , ′sH′, True) ) ]
```

Code Snippet defines a function returning spec for a stack of identical 1×3 rectangles rotated by multiple angles. Here nA=2 is the desired number of rotation angles. Variable a8 lists them as [0, 90] and a8 nm lists them as strings. The footprint boxH is 1 high and 3 wide (planks 902). The ‘D’ line defines two groups of hs=9 fiducial displacements. The first, called fidH_0, has members called fidH_0_m4, fidH_0_m3, . . . fidH_0_4 representing all the vertical displacements between-4 and 4 pixels. The second, called fidH_90, has members called fidH_90_m4, . . . fidH_90_4, representing the planks of the deck rotated 90° and arranged horizontally. The ‘B’ line defines a single backendNet called bakH_0 (the sole member of group GbakH) to be shared between all the planks. It takes input from the boxH footprint with Cin=4 channels and produces a single output. It is an MLP with 16 hidden units. The ‘C’ line names that output channel bakH_C_0, the sole member of group GbakH_C. The ‘U’ line creates two groups of unstructured predicates, one for each group of fiducial placements. These are named uH_0_0, . . . , uH_0_8 in group GuH_0 and uH_90_0, . . . , uH_90_8 in group GuH_90. The first ‘S’ line produces a group GsHA of two structured predicates, one for the conjunction representing the unrotated deck and one for the rotated deck. The final ‘S’ line forms the conjunction between the unrotated deck and the negated rotated deck.

This code could be simplified by introducing a capability to place structured predicates by recursing down to the unstructured predicates involved and placing them. At present, only unstructured predicates can be placed, so this was done explicitly.

Code Snippet 7:

```
def specs_sA2 (nA=8, shift=None) :
  if shift is not None:
shNm = re. sub ( ′ \-′, ′m′, f′sh {shift [0] }_{shift [1] } ′ )
  Unm = ′uA′ if shift is None else f′uA_{shNm} ′
  Snm = ′sA′ if shift is None else f′sA_{shNm} ′
  fidnm = ′fidA′ if shift is None else f′fidA_{shNm} ′
  return [
    # One symmetric 3×7 feature, rotated:
    (′D′, ( (′eqAngles′, nA, shift), fidnm) ) ,
    (′U′, ( (′GbakA_C′, ′pln′, (fidnm, ′i0′) ) , Unm, False) ) ,
    (′S′, ( ( ( ′motif′, ′conjWithNegPattern′, (1, 1, 1, 1, 1, 1, 1, 1) ) ,
      (′U′, f′G{Unm} ′) ) , Snm+′T′, False) ) ,
    (′S′, ( ( ( ′motif′, ′conjWithNegPattern′, (0, 0, 0, 0, 0, 0, 0, 0) ) ,
      (′U′, f′G{Unm} ′) ) , Snm+′F′, False) ) ,
    (′S′, (((′das1′, f′ (({ Snm}T_0) |
({Snm} F_0) ) ′ ) , None) , Snm, True) ) ]
```

Code Snippet 7 defines a function returning a rotationally symmetric pattern. This has commonalities with the second layer of the crop image network in in Code Snippet 2, but it has the complication that the rotated patterns must also be shifted, and also experiments with a modified definition of symmetry. The ‘D’ line defines nA=8 rotation angles about a shifted origin, and the ‘U’ line defines a corresponding group of unstructured predicates in terms of a placementNet and backendNet defined in Code Snippet 8. This group has the shift incorporated into its name, which begins with uA. The first ‘S’ line defines a structured predicate asserting that all these unstructured predicates hold true, in the manner seen elsewhere in the examples. The second ‘S’ line asserts that these unstructured predicates are all false, and the third that there is rotational symmetry if either of the first two apply. So this is an experiment with the idea that symmetry just means that the patterns should travel together, so to speak, whether all true or all false.

Code Snippet 8:

```
k=11; s=2; ha=3; wa=7; hs=9; ws=3; maxShift=2; nAsym=5; nB=3
pFlip=0.05 #pFlip=0.25
specs = [
  (′patchify′, ( (k, s, ′pfy′), ′pty′) ),
  (′L′, ( (′pn_basic3′, k, Cin, maxShift, None, None, (32, 16) ) , ′pln′,
True) ) ,
  ( ′footprint′, ( (′oddbox′, ha, wa) , ′boxA′ ) ) ,
  (′B′, ( (′simpleMLP′, ′boxA′, Cin, 1, 16) , ′GbakA′) ) ,
  (′C′, ( (′GbakA′, 0), ′bakA_C′) ) ,
  *specs_sA2 ( ) ,
  ( ′symbolizer′, ( (′flipBits′, (′pFlip′, pFlip) ), ′pSymzer′ ) ) ,
  ( ′symbolizer′, ( (′flipBits′, (′pFlip′, pFlip, ′lin′, 2, nAsym) ) ,
′aSymzer′ ) ) ,
  *specs_sH (2, aRange=180, hs=9, ws=3, Cin=Cin) ,
  *specs_sA2 (8, (0,−16) ),
  *specs_sA2(8, (0,16) ),
  (′S′, ( ( ( ′dasl′, ′sH_0 & sA_sh0_m16_0 & sA_sh0_16_0′) ,
None) , ′sWW′, True) ) ,
  (′lossSlices′, ( ( (′Iloss5′,
    ( ′S′, ′GsA′, ′pSymzer′) ,
    ( ′S ′ , ′GSH′ , ′pSymzer′ ) ,
    ( ′L′, ′A′, ′Gpln′, ′aSymzer′ ) ) , ) , ) )
  ]
```

Code Snippet 8 defines a full spec for the “water wings” predicate to identify “bridgeness”. Most of Code Snippet 8 can be understood from the discussion of previous examples. There is a call to specs_sH to set up the deck, but a total of three calls to specs_sA2 to set up the water. Only two of these, with fiducial shifts by 16 pixels to the left and right, appear in the final ‘S’ line that defines the “water wings” predicate sWW. The other, with no shift, appears only in ‘lossSlices’. This is another experiment. The thought is that there are plenty of examples of water in the images, and quite a few of decks or deck-like objects (such as roads), but not so many of decks situated relative to water in any particular manner. It would therefore be best to learn the deck and water features without reference to their relative placement. Having done that, the water-wings predicate (which does not appear in the loss either) should work.

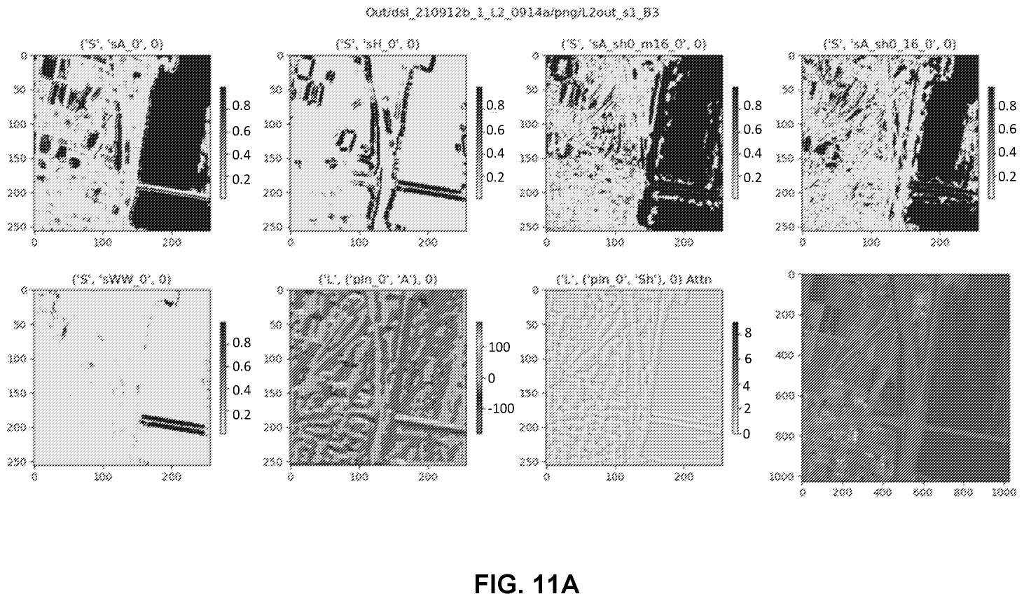

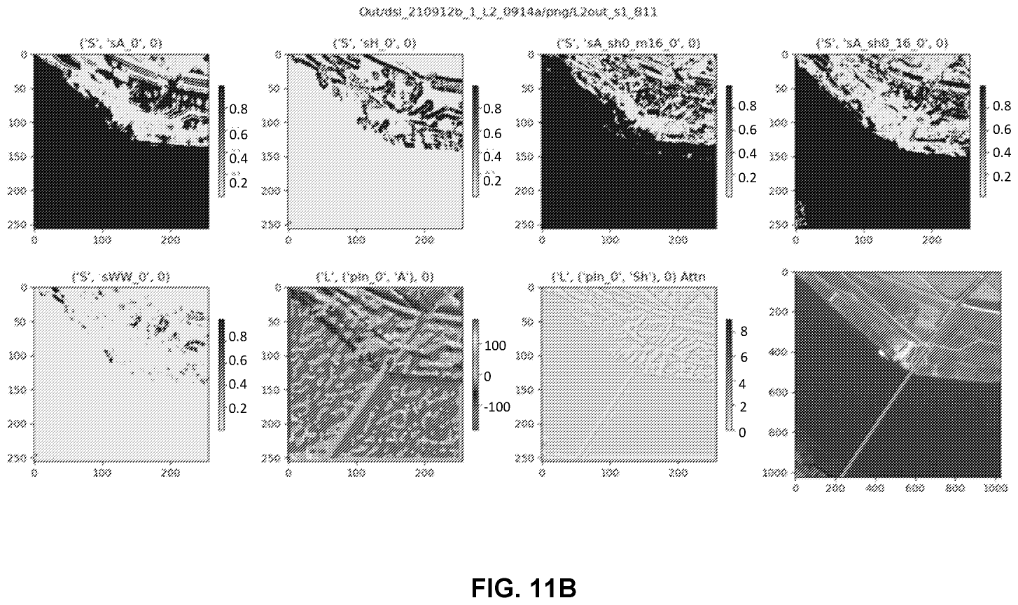

The network trained to 2.085 bits in about 15 minutes. An example of successful output is shown in FIG. 11A. It can be noted that the sWW predicate (lower left) zeroes in on the bridge seen in the original image (lower right). On closer inspection, it seems that sWW is more like a bridge edge detector. Two distinct edges can be seen in the sWW image, and from the angles (bottom, second from left) it can be seen that these are oriented about 180° apart. The water detector (top left) decently detected water. It occasionally classified fields or road pavement as water but interprets the bridge as non-water. The deck detector (top, second from left) also did pretty well, although it found water edges generally, not just at bridges. However, the shifted water (top two rightmost) largely eliminated the spurious edges, leaving only those occurring over water. Thus, the sWW conjunction behaved as intended.

FIG. 11B shows a failed example. It clearly failed because the deck predicate (top, second from left) failed to find the bridge, though it found many other edges, and the local placements, both shifts and angles, clearly responded to the bridge. It is a little hard to know what was driving the placements because the placementNet takes gradients propagated from all the predicates and also appears in the information objective along with sA and sH. Perhaps the bridge is too thin, and tweaking with scales or disjunctions across scales might help.

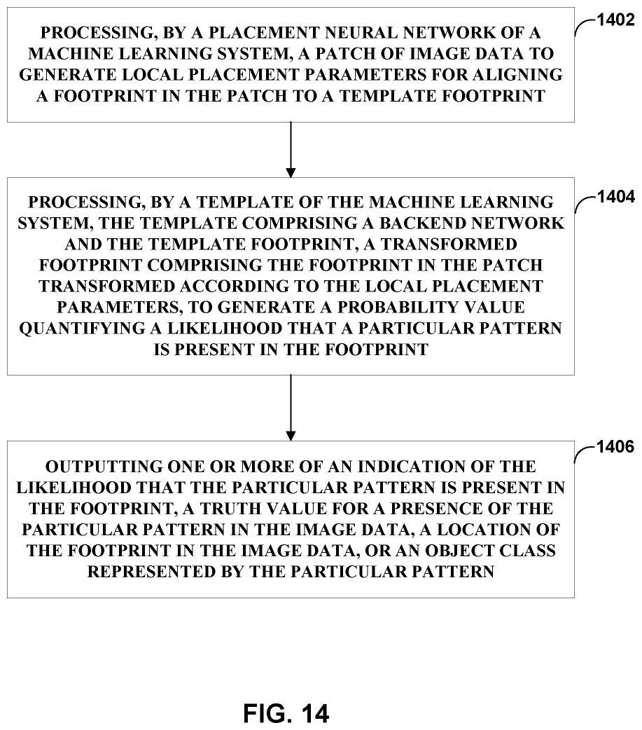

FIG. 14 is a flowchart illustrating an example mode of operation in accordance with the techniques of the disclosure. FIG. 14 is described with respect to FIG. 2. Soft logic block 200 is a component of a machine learning system executed by a computing system. Placement neural network 212 processes a patch of image data of images 112 to generate local placement parameters 208 for aligning a footprint in the patch to template footprint 206 (1402). Template 220 includes backend network 214 and template footprint 206. Template 220 processes a transformed footprint comprising the footprint in the patch transformed according to local placement parameters 208, to generate a probability value quantifying a likelihood that a particular pattern is present in the footprint (1404). The computing system outputs one or more of an indication of the likelihood that the particular pattern is present in the footprint, a truth value for a presence of the particular pattern in the image data, a location of the footprint in the image data, or an object class represented by the particular pattern (1406).

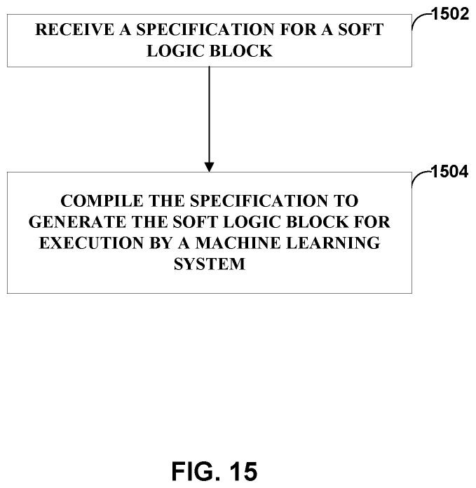

FIG. 15 is a flowchart illustrating an example mode of operation in accordance with the techniques of the disclosure. A computing system, that includes processing circuitry and a storage device, receives a specification for a soft logic block (1502). The computing system may include hardware components similar to those of computing system 100. The computing system may or may not include machine learning system 102. The computing system includes software instructions for implementing the mode of operation. The specification for the soft logic block defines a placement neural network configured to process a patch of image data to generate local placement parameters for aligning a footprint in the patch to a template footprint, and a template comprising a backend network and the template footprint, the template configured to process a transformed footprint comprising the footprint in the patch transformed according to the local placement parameters, to generate a probability value quantifying a likelihood that a particular pattern is present in the footprint. The computing system compiles the specification to generate the soft logic block for execution by a machine learning system (1504). The machine learning system may be executed by a separate computing system or by the same computing system.

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components, or integrated within common or separate hardware or software components.

The techniques described in this disclosure may also be embodied or encoded in a computer-readable medium, such as a computer-readable storage medium, containing instructions. Instructions embedded or encoded in a computer-readable storage medium may cause a programmable processor, or other processor, to perform the method, e.g., when the instructions are executed. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

1. A computing system for object detection, the computing system comprising processing circuitry and a storage device, wherein the processing circuitry has access to the storage device and is configured to execute a machine learning system comprising:
a placement neural network configured to process a patch of image data to generate local placement parameters for aligning a footprint in the patch to a template footprint; and
a template comprising a backend network and the template footprint, the template configured to process a transformed footprint comprising the footprint in the patch transformed according to the local placement parameters, to generate a probability value quantifying a likelihood that a particular pattern is present in the footprint.

2. The system of claim 1, wherein the machine learning system comprises:
a semantic logic layer configured to apply a logic formula to the probability value to generate a truth value for a presence of the particular pattern in the image data.

3. The system of claim 1, wherein the machine learning system comprises:
a semantic logic layer configured to apply a logic formula to the probability value and the local placement parameters to generate a truth value for a presence of the particular pattern in the image data.

4. The system of claim 1,
wherein the placement neural network comprises a first placement neural network,
wherein the template comprises a first template, and
wherein the machine learning system comprises:
a second placement neural network configured to process data received via an output channel of the backend network of the template to generate second local placement parameters for aligning a second footprint in the data to a second template footprint; and
a second template comprising a second backend network and the second template footprint, the second template configured to process transformed data comprising the second footprint in the data transformed according to the second local placement parameters, to generate a probability value quantifying a likelihood that a particular second pattern is present in the second footprint.

5. The system of claim 1, wherein the machine learning system is configured to transform the footprint in the patch by:
applying the local placement parameters to perform operations comprising one or more of shifting, scaling, or rotating the footprint template to identify image data comprising pixels included in the footprint template; and
interpolating the identified image data to generate the transformed footprint.

6. The system of claim 1,
wherein the template further comprises fiducial placement parameters that define a fiducial coordinate system, and
wherein the template footprint indicates spatial relationships among multiple objects by expressing locations of the multiple objects in terms of the fiducial coordinate system.

7. The system of claim 6, wherein the machine learning system is configured to transform the footprint in the patch by:
applying the fiducial placement parameters to perform operations comprising one or more of shifting, scaling, or rotating the image data to generate a fiducial frame of the image data;
applying the local placement parameters to perform operations comprising one or more of shifting, scaling, or rotating the footprint template to identify image data of the fiducial frame comprising pixels included in the footprint template; and
interpolating the identified image data of the fiducial frame to generate the transformed footprint.

8. The system of claim 1, further comprising:
an output device configured to output one or more of an indication of the likelihood that the particular pattern is present in the footprint, a truth value for a presence of the particular pattern in the image data, a location of the footprint in the image data, or an object class represented by the particular pattern.

9. The system of claim 1,
wherein the backend network is configured to output one or more output channels associated with respective object classes, and
wherein the backend network is configured to output an indication of an object class of the object classes, the object class represented by the particular pattern, via the corresponding output channel of the one or more output channels.

10. The system of claim 1, wherein the machine learning system further comprises:
a symbolizer configured to map one or more of the probability value or a truth value for a presence of the particular pattern in the image data to a scalar for use as input to a loss function.

11. The system of claim 1, wherein the machine learning system is configured to train the placement neural network and the backend neural network by processing training data comprising one or more input images to optimize a loss function.

12. The system of claim 11, wherein the loss function comprises an information-theoretic loss function.

13. The system of claim 1, wherein inputs to the loss function comprises data indicating one or more of the local placement parameters, the probability value, the transformed footprint, or a truth value for a presence of the particular pattern in the image data.

14. A computing system comprising processing circuitry and a storage device, wherein the processing circuitry has access to the storage device and is configured to:
receive a specification for a soft logic block, wherein the specification defines:
a placement neural network configured to process a patch of image data to generate local placement parameters for aligning a footprint in the patch to a template footprint, and
a template comprising a backend network and the template footprint, the template configured to process a transformed footprint comprising the footprint in the patch transformed according to the local placement parameters, to generate a probability value quantifying a likelihood that a particular pattern is present in the footprint; and
compile the specification to generate the soft logic block for execution by a machine learning system.

15. A method for detecting an object within image data, the method performed by a computing system executing a machine learning system and comprising:
processing, by a placement neural network of the machine learning system, a patch of image data to generate local placement parameters for aligning a footprint in the patch to a template footprint;
processing, by a template of the machine learning system, the template comprising a backend network and the template footprint, a transformed footprint comprising the footprint in the patch transformed according to the local placement parameters, to generate a probability value quantifying a likelihood that a particular pattern is present in the footprint; and
outputting one or more of an indication of the likelihood that the particular pattern is present in the footprint, a truth value for a presence of the particular pattern in the image data, a location of the footprint in the image data, or an object class represented by the particular pattern.

16. The method of claim 15, further comprising:
applying, by the semantic logic layer, a logic formula to the probability value to generate a truth value for a presence of the particular pattern in the image data.

17. The method of claim 15, wherein transforming the footprint in the patch comprises:
applying the local placement parameters to perform operations comprising one or more of shifting, scaling, or rotating the footprint template to identify image data comprising pixels included in the footprint template; and
interpolating the identified image data to generate the transformed footprint.

18. The method of claim 15,
wherein the template further comprises fiducial placement parameters that define a fiducial coordinate system, and
wherein the template footprint indicates spatial relationships among multiple objects by expressing locations of the multiple objects in terms of the fiducial coordinate system.

19. The method of claim 18, wherein transforming the footprint in the patch comprises:
applying the fiducial placement parameters to perform operations comprising one or more of shifting, scaling, or rotating the image data to generate a fiducial frame of the image data;
applying the local placement parameters to perform operations comprising one or more of shifting, scaling, or rotating the footprint template to identify image data of the fiducial frame comprising pixels included in the footprint template; and
interpolating the identified image data of the fiducial frame to generate the transformed footprint.

20. The method of claim 15, further comprising:
training the placement neural network and the backend neural network by processing training data comprising one or more input images to optimize a loss function.
